(19) United States
(12) Patent Application Publication
(10) Pub. No.: US 2026/0168382 A1
(43) Pub. Date: Jun. 18, 2026

(54) AERONAUTICAL THRUSTER WITH IMPROVED AEROACOUSTICS

(71) Applicant: SAFRAN AIRCRAFT ENGINES, Paris (FR)

(72) Inventors: Fernando GEA AGUILERA, MOISSY-CRAMAYEL (FR); Adrien Clément Marcel DUBOIS, MOISSY-CRAMAYEL (FR); Mathieu Simon Paul GRUBER, MOISSY-CRAMAYEL (FR); Eva Julie LEBEAULT, MOISSY-CRAMAYEL (FR); Anthony BINDER, MOISSY-CRAMAYEL (FR); Ludovic Mathieu Rene WIART, MOISSY-CRAMAYEL (FR)

(21) Appl. No.: 19/125,234

(22) PCT Filed: Oct. 30, 2023
(86) PCT No.: PCT/FR2023/051715

§ 371 Date: Apr. 28, 2025

(30) Foreign Application Priority Data
Oct. 31, 2022 (FR) FR2211373

(51) Int. Cl. F01D 5/14

(52) U.S. Cl. CPC F01D 5/142

(57) ABSTRACT

Aeronautical thruster having a longitudinal axis includes an upstream rotor row and a downstream stator row of unducted blades. Two adjacent blades of the downstream stator row have an azimuthal spacing between them, about the longitudinal axis, and at least some of these spacings differ from one another such that at least some of the blades of the downstream stator have a heterogeneous distribution about the longitudinal axis.

### TECHNICAL FIELD

The present disclosure relates to the field of aeronautical thrusters having a longitudinal axis, each thruster comprising a hub and (at least) two annular rows of unducted blades along the longitudinal axis, one upstream and the other downstream.

In accordance with the foregoing and the following, throughout this text, the relative terms “upstream” and “downstream” are defined relative to each other with reference to the flow of gases in a turbine engine in the longitudinal direction (i.e. the direction of the longitudinal axis) during the cruising flight phase.

The aeronautical thruster may comprise (at least) one heat engine, in particular a turbine engine, turboshaft engine, turbojet engine, turbofan engine, and/or (at least) one electric engine, and/or (at least) one hydrogen engine, and/or (at least) one hybrid engine: heat and/or electric and/or hydrogen engine.

### PRIOR ART

Reference will be made hereinafter more particularly, and therefore without limitation, to the case of turbine engines, as the type(s) of engine comprised in the thruster is not a determining factor here. Turbine engine is understood here to mean a thruster in which there is an exchange of energy between a flowing fluid and a rotor.

In this context, one will recall by way of example that a turbine engine with an “unducted” fan (or a turboprop engine of the “propfan” or “open fan” or “open rotor” or “Contra-Rotating Open Rotor” type) is a type of turbine engine in which the fan extends outside the engine casing (or nacelle), unlike conventional turbine engines (of the “turbofan” type) in which the fan is ducted.

The absence of a duct, such as unducted turbine engines, leads to an increase in the noise level emitted by the aeronautical thrusters, which typically comprise at least one upstream rotor row where the blades have an impact on the blades of a downstream stator row.

Indeed, the noise generated by the annular rows of unducted blades propagates in a free field. A main cause of the emitted noise is related to vortex structures generated in the airflow at the free radially external tips of the blades in the rotor row. These blade tip vortices can interact with the blades of a downstream stator row.

One of the challenges of these architectures is the certification of noise levels during takeoff and landing operations. The noise levels emitted by aircraft are subject to increasingly strict regulations.

The main sources of noise in unducted turbine engines are listed below:
noise from the generated blade tip vortices interacting with the rotor wake, if the rotor is followed downstream by a stator, the upstream rotor interacting with the leading edge of the downstream stator blades. This noise source contributes to the increase in:
   broadband noise, because the turbulence level in the wake is often very high at the blade tip,
   tonal noise, linked to the periodic nature of the wake from the upstream rotor and of the vortex during rotor blade rotation,
blade noise due to the stationary load on the blades (a source of tonal noise in a rotor) and to development of the boundary layer on the blades (rotor or stator); thus, the source of broadband noise is generated when the turbulent boundary layer passes the trailing edge of the blades; increasing the chord of blades in unducted turbine engines increases the surface area over which the boundary layer develops.

It should be noted that the absence of a nacelle on unducted turbine engines implies a significant reduction in surface areas that have acoustic treatments (honeycomb-type resonators, absorbent materials, in particular porous materials, etc.), and therefore means of noise reduction.

Furthermore, when a rotor is subjected to a non-uniform upstream flow that is not parallel to the engine axis—the aforementioned longitudinal axis—(flight angle of attack, with crosswind or installation-related effects), forces and moments appear in the propeller plane which are called 1P forces.

With a non-zero angle of attack, an upstream rotor followed by a downstream stator does not only provide a tractive force in the horizontal axis of forward motion of the aircraft (not necessarily the longitudinal axis (axis of the engine/aeronautical engine); it is the horizontal direction of forward motion). For example, when the aeronautical thruster is installed under a wing, and/or the thruster can be oriented with a certain angle of attack relative to the upstream flow, a descending rotor blade sees an increase in the angle of attack and is therefore subjected to increased forces, unlike an ascending blade on which reduced forces are exerted. Consequently, in the course of one engine rotation, the same rotor blade is subject to variable forces depending on its azimuthal position about the longitudinal axis.

Stator blades located downstream will therefore also have a variable load depending on their azimuthal position. Axially opposite to the upstream rotor blades, if, at the position of a given blade of the stator, the angle of attack as seen by the blade is significant to a greater or lesser extent, the descending blades of the stator will undergo less load and will have less twist to correct, while the rising blades will undergo more load and will have more twist to correct.

It should also be noted that the upstream angle of attack a (aircraft angle of attack) is not completely filtered out by the upstream rotor. In addition to the variation in 1P forces, the stator blades will be subjected to various angles of attack, due to the aircraft angle of attack and often the presence of a paired pylon (or equivalent)/airfoil, depending on their azimuthal position.

There will be positive angles of attack for the stator blades located in the upper part of the engine (zone around 12 o'clock), therefore more load; There will be negative angles of attack for the stator blades located in the lower part of the engine (zone around 6 o'clock), therefore less load.

As is conventional, the positions 3 o'clock, 6 o'clock, 9 o'clock, and 12 o'clock are considered to be as on a clock face and are oriented clockwise, as viewed when facing the thruster or aircraft concerned from upstream/the front.

However, various solutions of the prior art are often relatively suitable only in an isolated configuration of the aeronautical thruster and at zero angle-of-attack. Indeed, the presence of surrounding elements (strut, airfoil, fuselage, etc.), a non-zero angle of attack of the airflow as perceived by the thruster and the shape of the blades in the rotor row can modify, on the one hand, the contraction and axisymmetry about the longitudinal axis X of the flow tube of the airflow downstream of the rotor row, and/or on the other hand, the size of the vortices present in the airflow downstream of the rotor row, so that the truncation of blades of the downstream stator row as defined based on an isolated configuration and at zero angle of attack no longer prevents interaction between the blades of the downstream stator row and the vortices formed by the blades of the rotor row located upstream.

The present description aims to propose a solution to these disadvantages.

### SUMMARY

At this stage, let us immediately specify that, although the above prior art relates to a turbine engine, the solution of the invention applies to any unducted and/or “open rotor” type of aeronautical thruster, since part of the problem set forth above is not necessarily specific to the type of aeronautical thruster mentioned above.

In such context, an aeronautical thruster is therefore proposed, here and in general, which has a longitudinal axis (X) and comprises a casing and, spaced apart from each other along said longitudinal axis (X), an upstream rotor row of rotor blades which are unducted and a downstream stator row of stator blades which are unducted and extend around the casing, two adjacent blades of said downstream stator row of stator blades having an azimuthal spacing (Δθ, Δθᵢ) between them, about the longitudinal axis (X, or stator axis), that is defined by the angle between respective axes, the axes being either:
pitch angle adaptation axes of said two adjacent blades, when these axes are projected onto a plane perpendicular to the longitudinal axis (X) and if said two adjacent blades have a variable pitch angle, or
axes radial to the longitudinal axis (X) and/or passing through the radially internal ends or the radially external ends of said two adjacent blades, or through their centers of gravity, respectively, if said two adjacent blades have a fixed pitch angle, or
for one of said respective axes, a pitch angle adaptation axis of one of said two adjacent blades, when the blade has a variable pitch angle, and the other axis being radial to the longitudinal axis (X) and/or passing through the radially internal end or through the radially external end or through the center of gravity of said adjacent blade, when the latter has a fixed pitch angle, and
   about the longitudinal axis (X), an angular position at 12 o'clock is defined as being positioned vertically upwards relative to the longitudinal axis (X) and an angular position at 6 o'clock is defined as being positioned vertically downwards relative to the longitudinal axis (X),
   this assembly being characterized in that at least some of said blades of said downstream stator row of stator blades have a heterogeneous distribution about the longitudinal axis (X), such that there are at least two of said adjacent blades of said downstream stator row of stator blades which have an azimuthal spacing Δθ or Δθᵢ between them such that Δθᵢ≠360°/V; Δθᵢ≥(360°/V)+1° or Δθᵢ≤(360°/V)−1°, with V defining the number of blades in said downstream stator row of stator blades; and/or such that there are at least two azimuthal spacings between the stator blades of the downstream stator row such that Δθᵢ and Δθⱼ are different when i≠j with i,j≤V and i,j=1, 2, . . . .

Preferably, Δθᵢ≥(360°/V)+3° or Δθᵢ≤(360°/V)−3° will be chosen, or preferably Δθᵢ≥(360°/V)+5° or Δθᵢ≤(360°/V)−5°, in order to optimize the expected effects; these values have been observed to be particularly relevant with regard to the aforementioned desired effects, whereas one could expect different values.

Δθᵢ and Δθⱼ respectively define two different azimuthal spacings between any two adjacent blades. I and j are indices (natural numbers: i,j=1, 2, . . . ) which are different when i≠j and are less than or equal to the number of stator blades (i,j≤V), V defining the number of blades in the downstream stator row of stator blades. In other words: i and j are different and can take a (any) integer value among 1, 2, 3, . . . and (at most) V.

Expressed in another manner, at least some of the azimuthal spacings of the stator blades differ from each other.

Here, heterogeneous, non-homogeneous, irregular, and non-uniform are synonyms concerning this azimuthal distribution, therefore about the longitudinal axis X (heterogeneous=varied, not unique everywhere). Conventionally, the pitch angle of a blade can be the angle formed by the chord of one of the profiles and a plane perpendicular to the longitudinal axis X, for example the plane of rotation of the blade. Since the blade is twisted by design, by convention we say that the pitch is that of the profile located at 70% of the maximum radius.

Such a configuration makes it possible to take into account aerodynamic, acoustic, and/or integration constraints, if only in terms of compromises between them. In addition, this configuration is advantageous from a specifically acoustic point of view, for decorrelating the sources of noise emitted by the stator or for modifying the directivity of the sound radiated by the stator blades, i.e. the areas where there is maximal acoustic radiation.

Furthermore, increasing the number of stator blades in azimuthal positions close to the pylon (strut or engine mount) and/or to the airfoil or fuselage can be beneficial in reducing the potential effect (pressure buildup) of this assembly at the upstream rotor; locally increasing (relatively) the number of stator blades may therefore help “filter out” or reduce the pressure buildup at the upstream rotor, related to the presence of a strut, pylon, or engine mount, or of an airfoil (all of the lift surfaces of an aircraft) or of the fuselage.

From an acoustic point of view, the heterogeneous distribution of stator blades in the azimuthal direction (i.e. circumferentially about the axis around which the blades of said downstream stator row are arranged; longitudinal axis X in the example) makes it possible to modify the directivity of the interaction noise generated during the interaction of the upstream rotor wake with the downstream stator.

This makes it possible to define angular ranges around the main axis of the aeronautical thruster, within which the number of stator blades will be reduced in order to reduce the noise emitted towards the ground (“community noise”) and/or towards the passenger cabin (“cabin noise”).

From an aerodynamic point of view, the heterogeneous distribution of stator blades makes it possible to better distribute the aerodynamic load on stators during flight phases with a greater angle of attack (for example, the angle of attack is high during takeoff and/or landing), and the heterogeneity of the load on stator blades related to 1P forces (forces on the propeller blade in a direction perpendicular to the engine axis, which modifies the flow downstream of the upstream rotor as a function of its azimuthal position).

From an integration point of view, the heterogeneous distribution of stator blades makes it possible to bypass the ancillary equipment under the casing or hub, to reduce the pressure buildup at the airfoil/lift surface downstream of the stator blades, and/or to avoid the interaction of stator wakes with the airfoil, as well as to adapt to the integration of the pylon where appropriate. Note that it is known that a pylon may be located upstream of the rotor/stator blades (called a “pusher” configuration), unlike a preferred “puller” configuration where the pylon, and/or a row of stator blades, is at the level of the stator blades or downstream thereof, for a USF type of architecture. From an acoustic point of view, one advantage of a “puller” configuration is that it avoids the impact the wake from the pylon, strut, or engine mount would have on the rotor blade assembly. From an aerodynamic point of view, one advantage of a “puller” configuration is that it does not introduce distortion or heterogeneity into the airflow upstream of the rotor, which can degrade performance and increase the vibration response phenomena on the rotor blades. A puller configuration also allows the engine to be installed under the wing, which is an advantage for the aircraft manufacturer in terms of the aircraft's center of gravity.

The above solution thus also has the advantage of being particularly suitable for a USF type of aeronautical thruster. In this context, although a “puller” USF may be preferred, a “pusher” USF may be considered.

In the present document and in U.S. Pat. No. 9,242,721, the associated technical effects and problems are different. The problem identified in U.S. Pat. No. 9,242,721 is the formation of shockwave-related forces at the root of the rotor blades when the number of upstream rotor blades increases. The forces create aerodynamic losses and the reduction in the number of rotor blades increases the noise, because the blades undergo more load. To solve this problem for a contra-rotating rotor architecture (CROR), U.S. Pat. No. 9,242,721 proposes an additional ring of stator blades upstream of the rotor. The purpose of this stator ring (technical effect) is to avoid the formation of shockwave-related forces at the root of the blade (to improve efficiency/aerodynamics) and to be able to increase the number of rotor blades (to reduce noise).

In contrast, in the present solution, one can give preference to a USF type thruster comprising a single annular row of unducted rotor blades, which is the aforementioned upstream row of rotor blades, thus avoiding weight, technical complications related to integration, and aerodynamic interactions between the contra-rotating rotors.

The term “unducted”, used in reference to the upstream rotor row and the downstream stator row, indicates that the blades of the upstream rotor row and the blades of the downstream stator row are not surrounded by a nacelle (in other words, the stator blades have a radially external free end), unlike conventional aeronautical thrusters in which the fan is ducted inside a nacelle.

Given the above, the unducted upstream rotor row will extend around a hub, and the stator row, also unducted, will extend around a (fixed) casing, located downstream.

Some or all of the blades of the upstream rotor row and/or of the downstream stator row may be variable-pitch.

All the azimuthal spacings between two adjacent blades in the series of blades of said downstream row of stator blades may be different from each other.

This may be advantageous from an acoustic point of view, in decorrelating the sources of noise emitted by the stator or in modifying the directivity of the sound, i.e. the areas of maximal acoustic radiation.

A relevant situation may also arise if all blades of the downstream stator row have a homogeneous distribution about the longitudinal axis (X), except at a single angular sector. This “homogeneous distribution” may be such that: Δθ≤360°/V, for any azimuthal spacing between two (circumferentially) adjacent/successive blades concerned. The aforementioned angular sector will beneficially be limited to between 15° and 75°, or preferably between 25° and 60°. It will thus be possible to limit the noise emitted by the stator blades in connection with a less complex design than in other “heterogeneous” situations, while maintaining an optimized number of rotor and/or stator blades.

It will thus be possible to take into account the presence of a prominence or of a non-axisymmetric hub about the longitudinal axis X extending between two blades of said downstream annular row of stator blades, or axially adjacent to these two blades. In the presence of a pylon or engine mount or strut for attaching the thruster to the aircraft, it will be possible to have increased azimuthal spacing between the two stator blades that flank the prominence, for example the pylon.

This will be valid in particular for a number V of stator blades of interest which varies between 8 and 14.

In the above beneficial context, the number of blades in the downstream row of stator blades will effectively be greater than or equal to 5, for this investigation into reducing the noise emitted by stator blades and/or efficiency: ease of production/maintenance/dynamic effect on the flow.

The increase in spacing will, where necessary, allow ensuring the integration under the hub, typically in the nacelle therefore located downstream, of the attachment system for the aeronautical thruster, and/or the blade pitch (change) system, and/or the space for ancillary service conduits (oil, air, etc.).

It may also be advantageous to have, for at least one among the upstream rotor row of rotor blades and the downstream stator row of stator blades, a C/E ratio of the chord, C, and the azimuthal spacing, E, between two consecutive blades about the longitudinal axis (X), such that C/E is less than 3 over the entire span.

Even more advantageously, the C/E ratio may be less than 1 at the radially external ends of two blades of the same row (upstream and/or downstream) that are circumferentially or azimuthally consecutive, or adjacent.

This criterion will effectively be satisfied for a number of stator blades (between 8 and 14) that may be chosen as the preference. One advantage at a low solidity (C/E ratio) (C/E preferably less than 1 at the tip) is reducing blade-to-blade interactions. From an aerodynamic point of view, if the C/E is large (greater than 3 or 4), the channel or flow area of the flow between the blades is reduced. This increases the speed of the flow between the blades, which can produce shock waves (between the blades) and therefore losses of efficiency at certain operating points. From an acoustic point of view, the lower the solidity (C/E), the more the correlation of noise sources is reduced between blades.

One will recall that, conventionally, E is the length (in meters) of the circumferential arc between the axes (such as 180a/180b below) of two adjacent stator blades. It can be related to Δθ by the equation: E=r*Δθ where Δθ is measured in radians and r corresponds to the radial position about the longitudinal axis (X).

It may also be provided that the upstream rotor row of rotor blades and the downstream stator row of stator blades have different numbers of blades.

In the prior art, one disadvantage is linked to the addition of stators upstream of the rotor blades. Indeed, this runs the risk of creating new sources of noise, such as the interaction between the upstream stator wakes and the blades of the downstream rotor. Thus, the noise reduction that could be expected by increasing the number of blades of the upstream propeller may be (at least partially) masked by the new noise sources.

In contrast, in the present solution, it may be preferred that the number of blades of the upstream rotor is actually greater than the number of blades of the downstream stator, thus limiting the sources of unwanted or additional noise.

Thus, for example, in the case where the rotor blades and stator blades are distributed homogeneously in the azimuthal direction, using the solution of the invention with twelve of said blades in the upstream rotor row of rotor blades and eight of said blades in the downstream stator row of stator blades would generate four rotor wakes that could interact simultaneously with four stator blades, which could increase the noise emitted by the aeronautical thruster. But, with a heterogeneous azimuthal distribution of stator blades, this problem can be avoided, while maintaining the above optimized number of rotor and stator blades.

This is one example that illustrates the advantages of a heterogeneous azimuthal distribution of stators, but it will not necessarily be the preferred case. The preferred number of blades could in fact be (rotor-stator): 12-10 or 14-12 or even 14-11.

At least for wake equalization/limitation and noise limitation, it is also proposed that there be at least two families of stator blades in the row of stator blades, preferably at least three families of stator blades, and each family of stator blades comprises one or more stator blades having the same geometric characteristics (comprising at least the chord (C), the thickness (e), and the height (such as L2 or L21 hereinafter) of a stator blade) in which at least one of said geometric characteristics (at least chord, thickness, height) is different from the same geometric characteristics (chord, thickness, height) of the stator blades of another family of stator blades.

A set of geometric characteristics of a stator blade may comprise the chord, the thickness, and the height.

The set of geometric characteristics of a stator blade may further comprise at least one among the camber, the sweep, and the lean.

Also proposed are at least three families of stator blades, preferably at least five families of stator blades, and each family of stator blades comprises a stator blade in which at least one of the geometric characteristics in the set of geometric characteristics is different from the same geometric characteristics of a stator blade of another family of stator blades.

Also proposed are at least three families of stator blades, preferably at least five families of stator blades, and each family of stator blades comprises at least two or exactly two stator blades having the same set of geometric characteristics, at least one of the geometric characteristics in the set of geometric characteristics being different from the same geometric characteristics of the stator blades of another family of stator blades.

Also proposed are at least three families of stator blades, preferably at least five families of stator blades, and each family of stator blades comprises one or more stator blades, the stator blades of a same family comprising several stator blades having the same set of geometric characteristics, at least one of the geometric characteristics in the set of geometric characteristics being different from the same geometric characteristics of the stator blades of another family of stator blades.

It may also be provided that the row of stator blades comprises at least three adjacent stator blades which each belong to different families of stator blades. In other words, for three adjacent stator blades, each belonging to different stator blade families, it may be provided that the row of stator blades comprises three stator blades separated from each other by azimuthal spacings Δθᵢ and Δθᵢ₊₁ with i=1, 2, . . . and each belonging to different families of stator blades.

Furthermore, it is provided:
that max{Δθᵢ}−min{Δθⱼ}≤120°, preferably ≤75°, or even more preferably ≤50°, for i,j=1, 2, . . . when i≠j with i,j≤V and V≥5 (V: number of blades in said downstream row of stator blades), and/or
that ∥Δθᵢ−Δθ_{adjacent}∥≤120°, preferably ≤75°, or more preferably ≤50° with V≥5, would prevent too large of an angular sector from being completely without any stator blades, which could reduce the flow straightening downstream of the upstream rotor, thus generating:
an aerodynamic problem related to a loss of thrust and/or efficiency, and/or
problems of weight distribution and/or balancing about the longitudinal axis X and problems with the aforementioned integration.

One benefit of the aforementioned optimization of the angle values is to ensure that there are not more different azimuthal spacings than stator blades (physically impossible), as defined.

Δθᵢ and Δθ_{adjacent} are two angular sectors or azimuthal spacings (Δθ, Δθᵢ, Δθⱼ) which are adjacent to each other in the circumferential direction, i.e. having a common stator axis (axis around which the blades of stator 16 are circumferentially arranged).

The stator axis (axis around which the stator blades are radially arranged) may in general, of course, be the longitudinal axis X.

Furthermore, it is provided that the number of different azimuthal spacings (Δθ, Δθᵢ, Δθⱼ), across all the blades of said downstream row of stator blades, is between 2 and 6, would allow for better adaptation of the blade geometry to the local properties of the flow (impacted by angle of attack) and/or for better distribution of the weight of the vane ring (or blade ring, the two terms being used interchangeably) about the longitudinal axis (X) of the thruster.

Regarding the “angle of attack” aspect, note that the aircraft angle of attack (angle α hereinafter) can be defined as the angle between the longitudinal axis of the fuselage (axis X1 hereinafter) and the direction of the flow upstream of the fuselage (or the direction of advancement of the aircraft). There may be a non-zero angle (angle β below) between the longitudinal axis X of the thruster and the longitudinal axis X1 of the fuselage—denoted 33 below—or of the aircraft, when these axes are projected onto a vertical plane passing through the 12 o'clock and/or 6 o'clock positions and containing the longitudinal axis X of the thruster (angle β is sometimes called the “tilt angle” or “cant angle”). This is the plane to be taken into account in FIG. 2 mentioned below, where angle β is represented (here, in a non-exclusive/non-limiting manner, in a situation where the thruster is mounted under a wing—reference 31 below—of the aircraft concerned).

The longitudinal axis of the fuselage (or aircraft, X1 axis hereinafter) may be defined as the aircraft's roll axis, which may correspond to:
an axis running from the nose (upstream; reference 33a below) to the tail (downstream) of the fuselage, or alternatively
the axis passing through the most upstream and most downstream positions of the fuselage, in cruising flight.
   These axes X and X1 may not be parallel (β≠0°). For example, this can be useful for reducing the angle of attack and therefore the 1P forces perceived by the rotor blades during takeoff. To minimize these adverse effects on the aerodynamics and mechanical performance of the blades, the absolute value of angle β may vary between 0.5° and 30°, preferably between 2° and 20°, or more preferably between 3° and 10°.

The absolute value aspect of the angle (∥β∥) is important because the tilt:
should typically be downward if the thruster is installed under an aircraft wing, but
could be upward if installed towards the rear of the fuselage,
   this being so in order to limit the effects of the angle of attack during takeoff and/or landing.

In this regard, it may also be relevant for the invention to be applied to an aircraft (which will have a longitudinal axis (X1) and will comprise an aeronautical thruster as defined in the present text with all or part of the features mentioned, a fuselage, and a wing to which the thruster will be fixed), this aircraft beneficially being such that:
(the absolute value ∥β∥ of) the angle β between the longitudinal axis (X) of the aeronautical thruster and the longitudinal axis of the aircraft (X1) would vary between 0.5° and 30°, preferably between 2° and 20°, or more preferably between 3° and 10°, and/or
that: d1≠d2, d1 or d2 being less than 0.75*D, preferably less than 0.5*D, or more preferably less than 0.3*D.

As above, the interest in angle β relates to the increased efficiency during takeoff and/or landing and/or in installation towards the rear of the fuselage; the interest related to d1 or d2 is to cover the cases where the aeronautical thruster is attached to (in particular under) a wing, or more generally to any airfoil of the aircraft concerned.

Note that for a thruster according to the invention, fixed in front of the airfoil of an aircraft when facing it/viewing it from the front:
d1 may be defined as the axial distance (along the longitudinal axis X) between the trailing edge (TE) of the stator blade at the free end (denoted 25 below) and the leading edge (LE) of the airfoil (or wing), this being so for the stator blade closest (azimuthally) to the leading edge of the airfoil (or wing) and contained in the angular sector between 12 o'clock and 6 o'clock and including 9 o'clock (for example, in FIG. 10 mentioned below, d1 is measured relative to the circled blade denoted d1), and
d2 may be defined as the axial distance (along the longitudinal axis X) between the trailing edge of the stator blade at the free end and the leading edge of the airfoil (or wing), this being so for the stator blade closest (azimuthally) to the leading edge of the airfoil and contained in the angular sector between 12 o'clock and 6 o'clock and including 3 o'clock (for example, in the same FIG. 10, d2 is measured relative to the circled blade denoted d2).

In other words:
d1 may then concern the most radially internal stator blade (located as mentioned above: typically around 9 o'clock for a thruster positioned under the aircraft's right wing, or around 3 o'clock for a thruster positioned under the left wing), and
d2 may then concern the most radially external stator blade (located as mentioned above: typically around 3 o'clock for a thruster positioned under the right wing, or around 9 o'clock for a thruster positioned under the left wing).

To respond to cases of inappropriate blade loads (see above), it may be relevant for the invention to be applied to said aircraft which would then have the specific feature that the absolute value of said angle β (∥β∥) would vary between 0.5° and 30°, preferably between 2° and 20°, or more preferably between 3° and 10°.

Furthermore, it is provided that the ratio of:
the distance(S), along the longitudinal axis (X), between the two center planes perpendicular to the longitudinal axis, respectively of the upstream rotor row of rotor blades and of the downstream stator row of stator blades, and
the maximum diameter (D) of the aeronautical thruster, at the radially external ends of the blades of the upstream rotor row of rotor blades or of the downstream stator row of stator blades,
   (in other words, the spacing (S) between the pitch angle adaptation axis—or the axis where the centers of gravity of said blades are located—of the two upstream/downstream rows, and the engine diameter (D), therefore S/D)
   is between 0.01 and 0.8, and preferably between 0.15 and 0.35, making it possible to limit certain critical wake interferences between the two rows of blades and therefore to reduce noise while limiting the axial length of the aeronautical thruster.

If ground noise is to be reduced, the number of stator blades that extend towards the ground should be reduced. Thus, the largest angular azimuthal spacing(s) (Δθ, Δθᵢ, Δθⱼ) will then be located between the blades arranged between the angular positions between 8 o'clock and 4 o'clock (in the case of a pusher configuration with a pylon at 3 o'clock or 9 o'clock, there may be 16 stator blades between 10 o'clock and 2 o'clock), particularly or preferably at 2 o'clock and 4 o'clock and/or at 8 o'clock and 10 o'clock.

If wanting to facilitate a balancing of the thruster weight and avoid a residual moment on the longitudinal axis X linked to the heterogeneous distribution of the stators, preference will be given:
about the longitudinal axis (X) and viewed from upstream, to a distribution of the blades of the downstream row of stator blades located between 2 o'clock and 4 o'clock and those between 8 o'clock and 10 o'clock that is symmetrical relative to an axis of symmetry passing through the longitudinal axis (X) and through 12 o'clock and 6 o'clock, and
to said stator blades of the downstream row being positioned at symmetrical positions (θ and −θ) relative to the axis passing through the longitudinal axis (X) and through 12 o'clock and 6 o'clock having identical blade thicknesses and heights.

One will recall that:
a (blade) thickness corresponds to the maximum length or distance between the pressure side and the suction side of a section of this blade, in the direction perpendicular to a straight line which connects the leading edge with the trailing edge of the section,
a (blade) height is measured between a radially internal end 23 (at the hub or nacelle) and a radially external end 25 (free end) of the blade concerned.

To ensure that there is only one rotor blade wake interacting with a stator blade at a time, and therefore to reduce noise sources, the azimuthal spacing between the pitch angle adaptation axes of the blades of the upstream rotor row and of the downstream stator row will be defined by: ∥θ_{r,n}−θ_{s,m}∥>1° or preferably ≥2°,

where θ_{r,n} and θ_{s,m} correspond to the angular position of the pitch angle adaptation axis of the n^{th} blade of the upstream row of rotor blades and of the m^{th} blade of the downstream annular row of stator blades, respectively, at a time when the pitch change axes of a blade of the upstream row of rotor blades and of a blade of the downstream row of stator blades are aligned when projected onto a plane perpendicular to the longitudinal axis (X), n being a natural number varying between 1 and B, B being the number of blades in the upstream row of rotor blades and m being a natural number varying between 1 and V. More generally, for a stator blade of fixed or variable pitch, this will be the axis as defined by “stator axis”.

In connection with this unique wake effect, at least some of said blades in the upstream row of rotor blades and/or in the downstream row of stator blades may beneficially vary between each other in their chord (C) and thickness (e).

And, at least some of the blades in said upstream row of rotor blades could also have a heterogeneous distribution about the longitudinal axis (X).

In addition to an aeronautical thruster as mentioned above, the present description also concerns an aircraft having a longitudinal aircraft axis (X1), the aircraft comprising at least one such aeronautical thruster and a structure to which the aeronautical thruster is attached.

In this case, the structure of the aircraft will typically comprise a fuselage, and the angular sector, about the longitudinal axis (X), where the number of blades in the downstream annular row of stator blades is greatest may be located in the upper part and/or towards the fuselage.

Thus, noise emissions towards the ground will be limited and populations in the vicinity of airports will be protected. The noise from blades located towards the top and/or towards the inside could have reduced radiation towards the ground due to their azimuthal position and the possible screening effects produced by the airfoil (if located under/on the wing), the fuselage, and the strut, pylon, or engine mount for attaching the thruster to the aircraft.

In a different approach, if it is desired to minimize the noise radiated towards the passenger cabin and the acoustic interaction with the fuselage, then it will be preferred that the angular sector about the longitudinal axis (X) that has the greatest number of blades in the downstream row of stator blades, be located in the upper part and/or in an area of the downstream row of stator blades that is furthest from the fuselage.

Furthermore, increasing the number of stator blades in azimuthal positions close to the strut, pylon, or engine mount and to the airfoil (if the latter is in immediate proximity) may also be of interest in reducing the potential effect (pressure buildup) at the upstream rotor. It will then be advantageous to choose the angular sector, about the longitudinal axis (X), where the number of blades in the downstream row of stator blades is greatest, to be located where the distance is smallest, parallel to the longitudinal axis (X), between the trailing edge of the blades in the downstream row of stator blades and the leading edge of the airfoil.

Another possible consideration: that the stators facing the ascending rotor blades upstream undergo more load and have more twist to correct. For this purpose, it is recommended that the angular sector, about the longitudinal axis (X), where the number of blades in the downstream row of stator blades is greatest be located on a side of the thruster where the relevant blades in the upstream row of rotor blades are expected to be ascending, taking into account the direction of rotation defined for the upstream row of rotor blades.

This increase in the number of blades on that side will allow for better distribution of the stator load, which may also be beneficial for reducing noise.

Each blade in the upstream rotor row may extend in a radial direction from the hub so as to define a radial dimension (or blade height) between said hub and a radially external end of the blade in question, the individual dimension (possibly of each) of the blades in the upstream rotor row being greater than the radial dimension of each blade in the downstream stator row in question between said casing and a radially external end of the blade in question. In other words, the blades of the downstream stator row may be truncated at their free end in comparison to the blades of the upstream annular row. This limits the impact of vortices formed at the radially external end of the blades of the upstream rotor row, on the blades of the downstream stator row. A “truncated blade” means that the blade has a reduced radial dimension and/or a reduced radially external end (or end surface area). Alternatively, it may be provided that at least one blade of the upstream row has a radial dimension greater than that of at least one blade of the downstream row. In another alternative, it may be provided that at least one blade of the upstream rotor row has a radial dimension greater than the individual radial dimension (possibly of each) of the blades of the downstream row.

The radial dimension of a blade is measured between a radially internal end of the blade, the latter being located at (i.e. closest to) the hub (respectively the casing) of the aeronautical thruster, and a radially external end of the blade. The radially internal end of a blade may be, longitudinally, at the leading edge of the blade (for example, for a fixed blade) or at the pitch change axis of the blade in question. The radially internal end of a blade is also called the “blade root”.

The angular position of each blade, about the longitudinal axis, may be identified by the angular position about the longitudinal axis of the inner end of the respective blade. The radially external end of the blade is the end opposite to the radially internal end. The radially external end of the blade may be the free end of the blade. The radially internal end and the individual radially external end (possibly of each) of the blades may be radially aligned, i.e. at the same longitudinal position, or may be longitudinally offset from each other.

The downstream stator row may comprise between 3 and 25 blades. The number of blades in the upstream rotor row may be different from the number of blades in the downstream annular row, and B≥V+1 or more preferably B≥V+2 is preferred. This further minimizes the level of noise emitted by the aeronautical thruster.

As was already indicated with reference to the C/E ratio, the solidity of the downstream annular row, defined as the ratio between the chord and the spacing between two circumferentially consecutive blades in the circumferential direction, may be less than 3 over the entire radial dimension of each blade. In particular, in a preferred embodiment, the solidity is less than 1 at the radially external end of the blades.

The ratio of the distance in the longitudinal direction between a center plane of each annular row which is normal to the longitudinal axis, and the diameter of the aeronautical thruster, may vary between 0.01 and 0.8, and preferably between 0.15 and 0.35. The center plane normal to the respective longitudinal axis of each annular row may be the plane containing the respective pitch change axis of each of the blades of the corresponding annular row.

This limits or even avoids interference between the annular rows of blades.

The upstream rotor row and the downstream stator row may be located at an upstream end portion of the aeronautical thruster in the longitudinal direction, or at a downstream end portion of the aeronautical thruster in the longitudinal direction.

The aeronautical thruster may have a so-called “puller” configuration (upstream rotor row and downstream stator row located at an upstream end portion of the aeronautical thruster) or a so-called “pusher” configuration (upstream rotor row and downstream stator row located at a downstream end portion of the aeronautical thruster).

In the puller configuration, the upstream rotor row and the downstream stator row may surround a section of the compressor(s) or of the reduction gearbox of the aeronautical thruster. In the pusher configuration, the upstream rotor row and the downstream stator row may surround a section of the turbine(s) of the aeronautical thruster.

According to one aspect, the aeronautical thruster may successively comprise, from upstream to downstream along the longitudinal axis (X):
at least one compressor,
at least one combustion chamber,
at least one turbine driving the compressor(s), and
an air inlet to the compressor(s), the air inlet being located downstream of the upstream rotor row of rotor blades, and upstream of the downstream stator row of stator blades, in other words, longitudinally along the propulsion unit, between the rotor blades and the stator blades.

According to another aspect, a propulsion assembly for an aircraft is described, comprising an aeronautical thruster as described above and an attachment pylon for fixing the aeronautical thruster to the aircraft, the attachment pylon being connected to one of the blades of the downstream stator row so as to form a single aerodynamic assembly.

According to another aspect, an aircraft is described comprising an aeronautical thruster as described above or a propulsion assembly as described above.

### BRIEF DESCRIPTION OF DRAWINGS

Other features, details and advantages will become apparent upon reading the detailed description below, and upon analyzing the attached drawings, in which all the blades are unducted, and:

FIG. 1 is a partial schematic cross-section view of a turbine engine usable in this context, therefore having an upstream rotor and a downstream stator, in a “pusher” configuration,

FIG. 2 is a schematic view of a thruster in a configuration that can be a “puller” configuration, in a phase that can be a takeoff phase, therefore with an aircraft angle of attack (angle α);

FIG. 3 is a partial schematic cross-section view of a turbine engine usable in this context, in a “puller” configuration,

FIG. 4 can represent the turbine engine of FIG. 3 in section plane IV-IV (stator) normal to the longitudinal axis X, with an example of one possible arrangement of the annular row of blades of the downstream stator,

FIG. 5 is a schematic view in the same section plane as in FIG. 4, from the front (viewed from upstream), illustrating another arrangement of the annular row of blades of the downstream stator;

FIG. 6 is a schematic view, again in the same section plane, illustrating another arrangement of the annular row of blades of the downstream stator;

FIG. 7 is a schematic view, again in the same section plane, illustrating another arrangement of the annular row of blades of the downstream stator;

FIG. 8 is a schematic view, again in the same section plane, illustrating another arrangement of the annular row of blades of the downstream stator;

FIG. 9 is a schematic view, again in the same section plane, illustrating another arrangement of the annular row of blades of the downstream stator;

FIG. 10 is a schematic front half-view (viewed from upstream) of the solution of FIG. 9, with under-wing attachment of the thruster;

FIG. 11 is a schematic top half-view of FIG. 10, with a stator blade configuration which may be that of FIG. 4 or 9;

FIG. 12 is a schematic view, again in the same section plane as in FIG. 4, illustrating another arrangement of the annular row of blades of the downstream stator;

FIG. 13 is a schematic view, again in the same section plane, illustrating another arrangement of the annular row of blades of the downstream stator;

FIG. 14 shows, again in the same section plane, a desired azimuthal spacing between the blades of the upstream rotor and those of the downstream stator;

FIG. 15 is a diagram of the unitary integration of at least one downstream stator blade into the attachment system for fixing the thruster to the aircraft;

FIG. 16 shows another solution, with mounting via an engine mount between the thruster and a wing of the aircraft;

FIG. 17 shows a diagram of an aircraft equipped with two thrusters attached to the fuselage via struts, each thruster having a heterogeneous azimuthal spacing of the blades in the downstream stator,

FIG. 18 and

FIG. 19 show a diagram of a stator blade (downstream blade) and a manner of considering the pitch angle of this blade, FIG. 19 corresponding to section XVIII-XVIII of FIG. 18, this and FIG. 2 indicating the air flows around the thruster (lines with multiple arrowheads);

FIG. 20 schematically shows the angle, or “azimuthal spacing” Δθᵢ or Δθⱼ, between two consecutive stator blades, and

FIG. 21 can supplement FIG. 2, and schematically represents a case with the aircraft angle of attack in a side view, with a thruster in a configuration that can be a “puller” configuration, in a phase that can be a takeoff phase, therefore with a non-zero angle β in the example.

### DESCRIPTION OF EMBODIMENTS

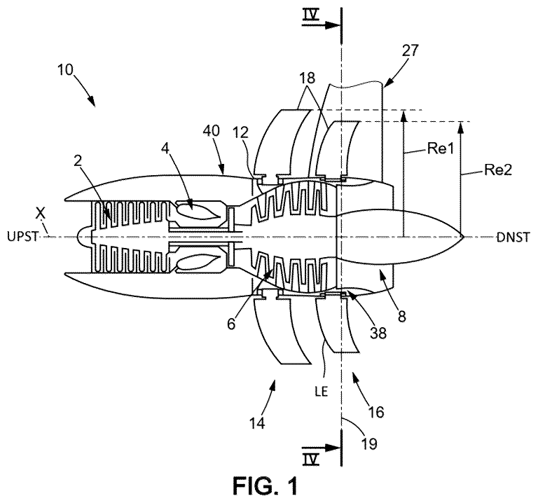

As an example, an aeronautical thruster compatible with what is proposed in the invention could be a turbine engine, as in FIGS. 1 to 3.

Any thruster referred to here, such as turbine engine 10, comprises a hub 12 located upstream (UPST) of an engine casing 13. An annular upstream rotor row 14 of unducted blades 18 is mounted on (around) hub 12, and an annular downstream stator row 16 of unducted blades 18 is mounted on (around) engine casing 13. The two rows are spaced apart from each other along a longitudinal axis X of turbine engine 10.

Hub 12 and engine casing 13 may be combined under the term nacelle 40, the nacelle 40 being the structure around which the blades 18 of rotor 14 and stator 16 are arranged and extend. Nacelle 40 is fixed to the aircraft that the aeronautical thruster referred to here is to drive.

As will already have been understood, orientation qualifiers such as “longitudinal”, “radial”, or “circumferential” are defined with reference to the longitudinal axis X of the thruster concerned, as in turbine engine 10. The longitudinal direction corresponds here to the direction of advancement of the thruster or to the axis of rotation of the blades of the upstream rotor 14. In particular, the longitudinal direction may be coincident with a horizontal direction, i.e. perpendicular to the gravitational field. The relative qualifiers “upstream” (UPST) and “downstream” (DNST) are defined relative to each other with reference to the flow of gases in the thruster, along the longitudinal direction. The angular position of each of blades 18 around longitudinal axis X is identified in relation to a clock face (here viewed from upstream for example) on which the angular positions at 12 o'clock, 3 o'clock, 6 o'clock, and 9 o'clock are positioned in the conventional manner. The angular position at 12 o'clock is therefore positioned vertically upwards relative to longitudinal axis X, and the angular position at 6 o'clock is positioned vertically downwards relative to longitudinal axis X. The angular position at 3 o'clock is positioned horizontally to the right relative to longitudinal axis X, and the angular position at 6 o'clock is positioned horizontally to the left relative to longitudinal axis X. An axis extending radially through the angular positions at 12 o'clock and 6 o'clock is thus perpendicular to an axis extending radially through the angular positions at 3 o'clock and 9 o'clock. Absolute position qualifiers such as the terms “up”, “down”, “left”, “right”, etc., or relative position qualifiers such as the terms “above”, “below”, “upper”, “lower”, etc., and orientation qualifiers such as the terms “vertical” and “horizontal”, refer here to the orientation in the figures and are considered to be when the thruster is in an operational state, typically when it is installed on an aircraft located on the ground. In this state of turbine engine 10, the axis passing through the angular positions at 12 o'clock and 6 o'clock extends in the direction of the gravitational field, i.e. vertically. It can be deduced, however, that a rolling movement during flight of the aircraft on which the thruster is mounted will be such that it causes a rotation of the vertical and horizontal directions about the longitudinal axis X as considered in the figures. In the same manner, a rolling movement during flight of the aircraft on which the thruster is mounted will be such that it causes a rotation of the axis passing through the angular positions at 12 o'clock and 6 o'clock and of the axis passing through the angular positions at 3 o'clock and 9 o'clock, about the longitudinal axis X. A “lateral area” of turbine engine 10 refers to an area which is circumferentially in the vicinity of the angular position at 3 o'clock or the angular position at 9 o'clock. Similarly, an “upper area” and a “lower area” of the thruster respectively refer to an area which is circumferentially in the vicinity of the angular position at 12 o'clock and to an area which is circumferentially in the vicinity of the angular position at 6 o'clock.

Thus, downstream stator row 16 (or stator) is fixed around longitudinal axis X. In other words, downstream stator row 16 is not rotated about longitudinal axis X. This does not exclude the possibility that each blade 18 of downstream stator row 16 may have a variable pitch.

If the aeronautical thruster concerned is (or comprises) a turbine engine, it will therefore be a turbine engine successively comprising, parallel to the longitudinal axis (X), from upstream to downstream inside nacelle 40 (including under engine casing 13):
one (or more) compressor(s) 2,
at least one combustion chamber 4,
one (or more) turbine(s) 6 driving the compressor(s), and
at least one exhaust nozzle 8.

Among these turbine engines with unducted fans, there are the known “Unducted Single (or Stator) Fan” (USF) turbine engines, in each of which, as illustrated in FIGS. 1 to 3, upstream rotor row 14 of unducted blades 18 is mounted so as to rotate about longitudinal axis X and downstream stator row 16 of unducted blades 18 is fixed. The direction of rotation of blades 18 of upstream rotor row 14 (or rotor) is not a determining factor.

Downstream stator row 16 may be centered on an axis that may or may not be coincident with longitudinal axis X. In the examples presented, downstream stator row 16 is centered on longitudinal axis X. Such a configuration of upstream rotor row 14 and downstream stator row 16 makes it possible to utilize, through downstream stator row 16, the energy of the swirling airflow from upstream rotor row 14. The efficiency of turbine engine 10 is thus improved, in particular compared to a single rotating propeller (such as 14) in the case of a conventional turboprop. Upstream rotor row 14 is rotated about longitudinal axis X by turbine(s) 6, which drive(s) compressor(s) 2. Turbine engine 10 generally comprises a reduction gearbox in order to decouple the rotational speed of turbines 6 from the rotational speed of upstream rotor row 14. Furthermore, one of the advantages of a USF type of turbine engine compared to a “Contra-Rotating Open Rotor” type of turbine engine is to reduce the tonal noise emitted by the turbine engine, because downstream stator row 16 of unducted blades 18 is fixed.

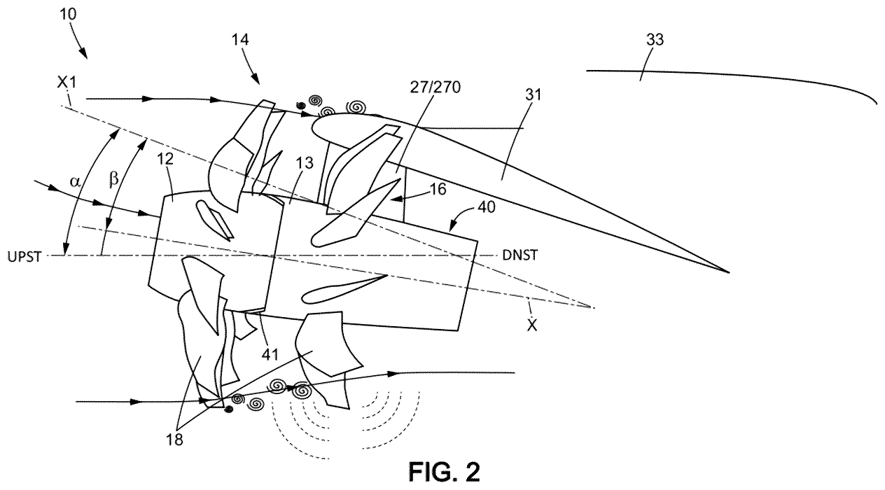

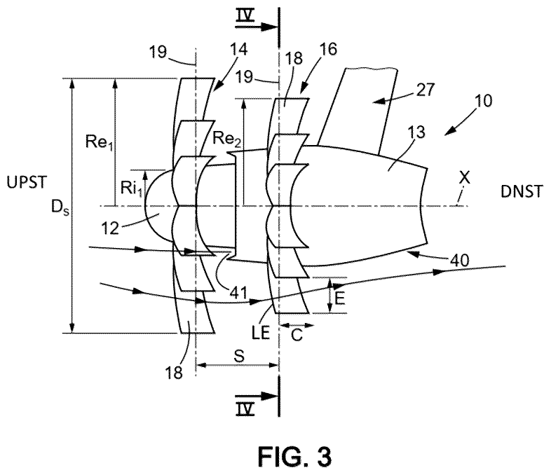

As is schematically shown in FIGS. 2 and 3, the thruster may have a “puller” configuration (upstream rotor row 14 and downstream stator row 16 located at an upstream end portion of the thruster) or, as is schematically shown in FIG. 1, a “pusher” configuration (upstream rotor row 14 and downstream stator row 16 located at a downstream end portion of the thruster).

In the puller configuration, upstream rotor row 14 and downstream stator row 16 may surround a section of compressor(s) 2 of the turbine engine or of the reduction gearbox. In the pusher configuration, upstream rotor row 14 and downstream stator row 16 may surround a section of turbine(s) 6 of turbine engine 10.

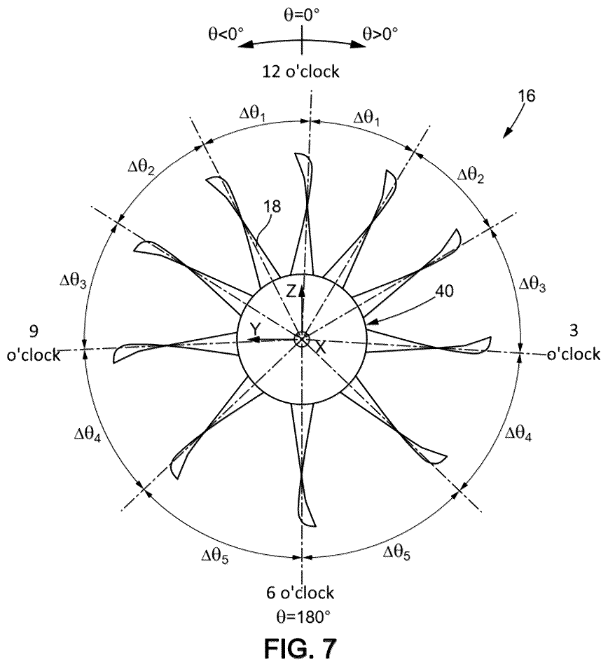

Regardless of the type of thruster (turbine engine, hybrid, etc.), an attachment system 27 will allow fixing the thruster to aircraft 29 equipped with the thruster, and more precisely to its airfoil (wing) 31, or to its fuselage 33, or to any other suitable part. Typically, this may be done using:
for a fuselage: a strut 35 (as in the examples of FIGS. 3, 7), or
for attachment to a wing or aerofoil: a pylon 37 (for example as in FIGS. 3, 11) or an engine mount 39 (for example as in FIG. 16).

Blades 18 of upstream rotor row 14 and/or of downstream stator row 16 may be variable pitch blades. It is thus possible to adapt the pitch of blades 18 of turbine engine 10 according to the operating point of the thruster or the flight phase. A pitch change system 38 may be provided, located partly in nacelle 40 (hub 12 and/or casing 13), in order to adapt the blades' angle of attack for each flight phase. The rotation of each blade 18 may thus be adjusted about a respective pitch change axis 19. The individual pitch change axis 19 (possibly for each) of blades 18 is an axis:
extending radially and/or positioned longitudinally at a median portion of the respective blade, and
around which the pitch angle of a blade may be adapted.

In this regard, the present disclosure covers the cases where:
the pitch change axis is perpendicular to longitudinal axis X,
the pitch change axis is not perpendicular to longitudinal axis X, i.e. it is inclined; for example, if the pitch change axis has a longitudinal component and/or a circumferential component, in reference to longitudinal axis X.

In order to (re)define, if necessary, the pitch angle of a blade more precisely, it is specified that each downstream stator blade 18 defines an aerodynamic profile. For this purpose, each downstream stator blade comprises a stack of sections 30 along the radial direction. One of sections 30 is shown in FIG. 18. Each section 30 extends in a respective section plane which is perpendicular to the radial direction of extension of the corresponding downstream stator blade. Each section 30 comprises an upstream leading edge and a downstream trailing edge between which extend a pressure-side line 330 and a suction-side line 340. Each section 30 defines an aerodynamic profile. Each section 30 also comprises a chord C defined by a straight line segment connecting the leading edge to the trailing edge.

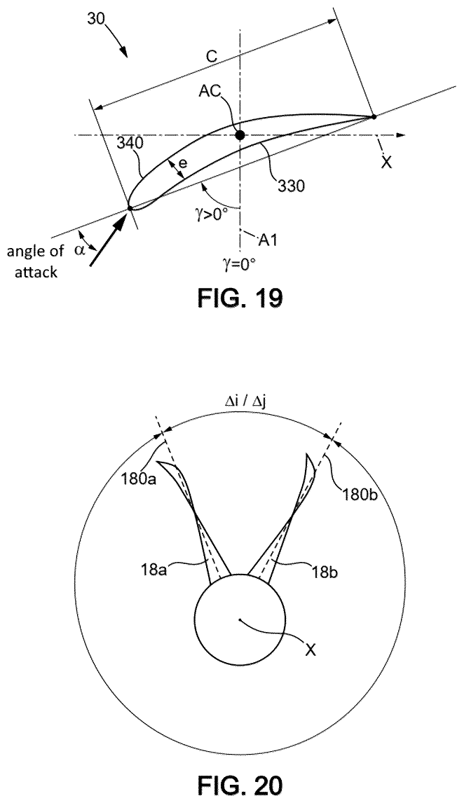

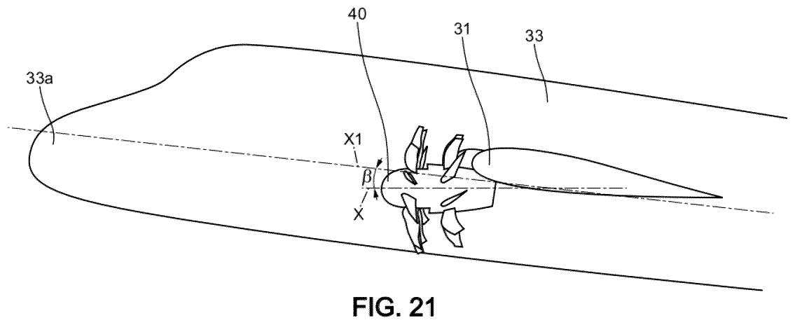

The pitch angle γ of each downstream stator blade 18 (see for example FIGS. 18-19) will correspond to the angle formed between, on the one hand, a first axis A1 which is defined by the intersection between the section plane of a reference section 30 among the stack of sections 30 of the downstream stator blade and a plane perpendicular to longitudinal axis X which may comprise pitch axis AC of the downstream stator blade (when the pitch change axis is perpendicular to axis X, which is normally the case but is not obligatory), and on the other hand, chord C of reference section 30 of downstream stator 16 blade. Pitch angle γ is measured at the upstream side of the plane perpendicular to longitudinal axis X, which, as above, may comprise pitch axis AC of downstream stator blade 18. Pitch angle γ is measured positively in a direction oriented from first axis A1 towards chord C of reference section 30, and more particularly in a direction that is coincident with the direction oriented from pressure-side line 330 to suction-side line 340.

Here, reference section 30 of each downstream stator blade 18 is located, on the corresponding downstream stator 16 blade, at a radial distance from longitudinal axis X which corresponds to 75% of the radially external radius of the corresponding downstream stator blade.

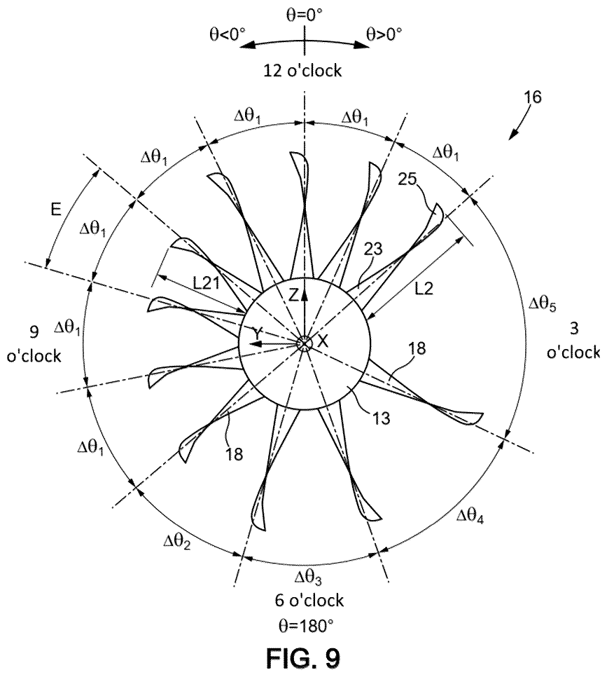

Each blade 18 of upstream rotor row 14 and of downstream stator row 16 extends in a radial direction from hub 12 so as to define a radial dimension between said hub 12 and a radially external end of the respective blade 18. In other words, the radial dimension of a blade 18 corresponds to its height between said radially internal 23 and radially external 25 ends. The radially internal end of each blade 18 is located at hub 12 of turbine engine 10. Each blade 18 may in particular be fixed to hub 12 of turbine engine 10 at the radially internal end. The radially external end of each blade 18 is here a free end (i.e. unducted). It is specified that the span of a blade 18 is consequently the radial distance between its inner 23 and outer 25 ends (see FIG. 9), with:
L1=Re1−Ri1 for a blade of the upstream rotor row, and
L2=Re2−Ri2 for a blade of the downstream stator row.

Furthermore, each blade 18 of upstream rotor row 14 and of downstream stator row 16 has a radially internal radius, respectively Ri1, Ri2, considered to be the radial distance from longitudinal axis X of the radially internal end of blade 18, for example located at (i.e. closest to) hub 12 (rotor row) or casing 13 (stator row). Radially internal end 23 is, in FIG. 3, close to the pitch change axis of the respective blade. The radially internal end of each blade may alternatively be close to the leading edge at the blade root. A radially external radius, such as Re1 or Re2 in FIG. 3, of each blade 18 is considered to be the radial distance from longitudinal axis X of the radially external end of said blade 18, i.e. the maximum radius of the blade.

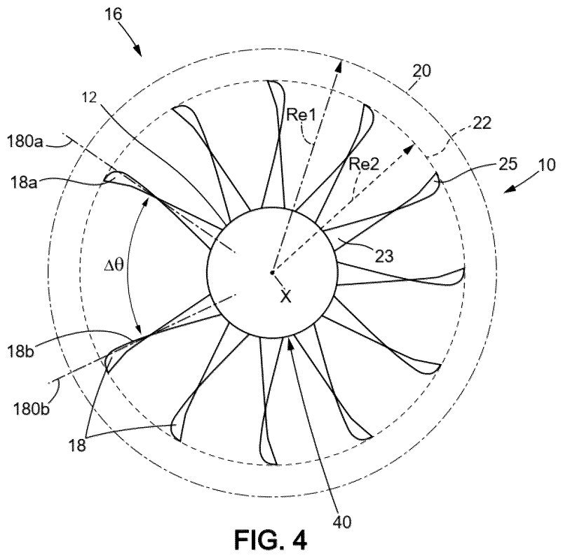

As can be understood by viewing FIG. 4 as an example, radially external end 25 of blades 18 of upstream rotor row 14 and of downstream stator row 16 are respectively inscribed within an encircling envelope 20 around upstream rotor row 14 and an encircling envelope 22 around downstream stator row 16.

A projection onto section plane IV-IV (see FIG. 1 or 3), of encircling envelope 20 of downstream stator row 16 may define a circle of radius Re2, or of diameter Ds, which may be centered on longitudinal axis X (Ds=2*Re2).

Diameter D, or circle of radius Re1, in a radial section plane at encircling envelope 20 of upstream rotor row 14, can represent the outside diameter of the thruster considered, which is turbine engine 10 in the example (see FIG. 1 or 3).

The radial dimension of each blade 18 of downstream stator row 16 may be less than the individual radial dimension (possibly of each) of blades 18 of upstream rotor row 14, so as to limit the impact of the vortices formed at the radially external end of blades 18 of upstream rotor row 14 on blades 18 of downstream stator row 16. Encircling envelope 20 of upstream rotor row 14 will then surround encircling envelope 22 of downstream stator row 16 when these envelopes are projected onto a common projection plane normal to longitudinal axis X, such as section plane IV-IV here.

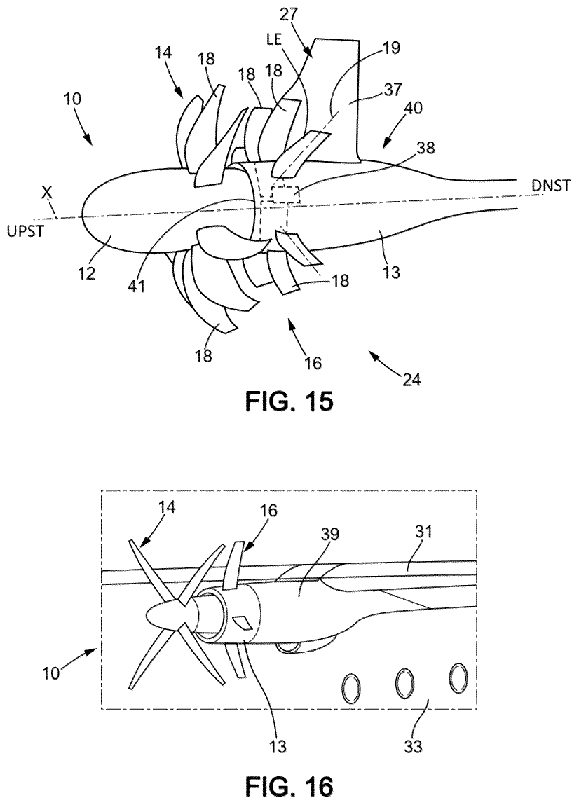

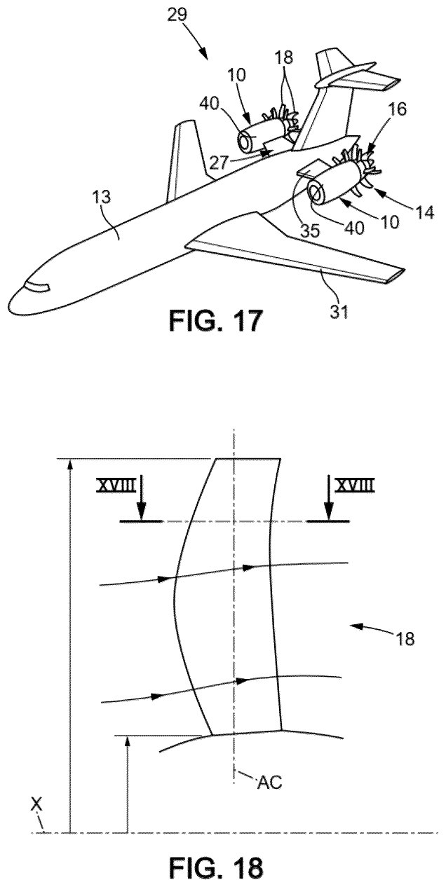

This must be compatible with clipping (i.e. truncation of the downstream stator blades, as in the solution(s) associated with FIG. 3 or 15 as non-limiting examples) over 360°, it being specified that homogeneous clipping is not necessarily a requirement. In other words, there may be at least one blade 18 of downstream stator row 16 having a radius Re2 which allows defining circle 22, but other blades of downstream stator row 16 could have a smaller radius than Re2.

Furthermore, here again to encourage a more balanced control over blade loads and generated noise, it is proposed that:
each blade of the downstream stator row 16 of stator blades therefore has a height, L2 or L21 in the non-limiting example of FIG. 9, between radially internal end 23 and the radially external end 25,
the respective heights, such as L2 and L21, of at least two blades 18 of said downstream stator row 16 are beneficially and advantageously different.

It should also be noted that the projection of the encircling envelope of downstream stator row 16 onto a common projection plane normal to longitudinal axis X, such as section plane IV-IV in the example, may also define a circle, or even an oval as above, in which the center may be offset relative to longitudinal axis X, for example along the direction of the axis passing through the angular positions at 12 o'clock and 6 o'clock. The radial distance between the center of encircling envelope 22 of downstream stator row 16 having a circular shape and longitudinal axis X may be between 0.005 Ds and 0.2 Ds.

The circle/oval defined by encircling envelope 22 of downstream stator row 16 may have a radius Re2 (for example the maximum radius if an oval shape) that is less than the radius Re1 (for example the maximum radius if an oval shape) of encircling envelope 20 of upstream rotor row 14.

Thus, the heterogeneous distribution of blades 18 of downstream stator 16 (in the azimuthal direction) may be compatible with other noise reduction technologies, such as “360° clipping”. It is therefore possible, over at least one angular sector:
to arrange blades 18 of downstream stator 16 heterogeneously (in the circumferential direction), and
for blades 18 of downstream stator 16 to each, or individually, have a maximum radius (Re2) or height that is less than the maximum radius (Re1) or height of blades 18 of upstream rotor 14.

In this case, there may be shorter blades 18 of stator 16 between 8 o'clock and 4 o'clock (in the case of a pusher configuration with a pylon at 3 o'clock or 9 o'clock, there may be blades of stator 16 between 10 o'clock and 2 o'clock). However, it may be possible in particular or preferably to favor stator blades in the lower part (between 4 o'clock and 8 o'clock) and at the sides (between 2 o'clock and 4 o'clock or between 8 o'clock and 10 o'clock, towards the exterior and/or towards the fuselage); all of this in order to minimize interaction noise during phases with a greater angle of attack (landing/takeoff).

The center of the circle in which radially external end 25 of each blade 18 of the downstream stator row 16 of stator blades is inscribed could be offset relative to longitudinal axis X, making it possible to adapt the configuration of these blades to their environment (position on the aircraft/types of noise to be controlled/fluid flow to be facilitated/mechanical constraints to be satisfied, etc.).

Having fewer blades in stator 16 than in upstream rotor 14 could also be useful in combining noise reduction, aerodynamic efficiency, less stress from the load on certain blades of the downstream stator, and weight and size reduction. It is recommended that: B≥V+1, or preferably B≥V+2.

In accordance with an important aspect mentioned above, it is therefore of interest here to have a heterogeneous azimuthal spacing of the blades of downstream stator 16, for the reasons mentioned: aerodynamic, acoustic, and/or integration constraints.

Several embodiments are conceivable depending on the objective (aerodynamic, acoustic, integration, etc.) or on the desired compromise across professional areas of focus.

As indicated above, two adjacent blades, such as 18a, 18b, of the downstream stator row 16 of stator blades have an azimuthal spacing (Δθ, Δθᵢ, Δθⱼ) between them, about the longitudinal axis (X), defined by the angle between their respective axes 180a, 180b.

These respective axes, on stator 16, are:
either pitch angle adaptation axes (abovementioned axis 19) of said two adjacent blades, when these axes are projected onto a plane perpendicular to longitudinal axis X and if said two adjacent blades have a variable pitch angle,
or axes radial to longitudinal axis X and/or passing through radially internal ends 23 or radially external ends 25 (maximum radius, Re2 in FIG. 4), or through the centers of gravity of said two adjacent blades, respectively, if said two adjacent blades have a fixed pitch angle,
or:
   for one of said respective axes, a pitch angle adaptation axis of one of said two adjacent blades (abovementioned axis 19), when the blade, such as 18a, has a variable pitch angle,
   the other being radial to longitudinal axis X and/or passing through radially internal end 23 or through radially external end 25 or through the center of gravity of said adjacent blade, such as 18b, when the latter has a fixed pitch angle.

Thus axes 180a, 180b, 19 are interchangeable in the cases presented and may be interchanged, in particular in the figures.

As an example, FIG. 20 schematically shows what the angle, or “azimuthal spacing” Δθᵢ or Δθⱼ, is between two consecutive stator blades, such as blades 18a, 18b with respective radial axes 180a, 180b. This is the smaller angle of the two, circumferentially, between axes 180a, 180b, here about axis X.

In the case where one of the stator blades is fixed (for example for integration constraints, for example if there is a lack of space under the hub for integrating pitch change system 38 or to reduce the weight), the main axis of the blade may therefore be defined by the line perpendicular to longitudinal axis X passing through the leading edge (LE) at blade root 23 or passing through the center of gravity of the blade or at blade tip 25 (maximum radius, Re2).

In this context, to present the desired heterogeneous distribution around longitudinal axis X, at least some of blades 18 of downstream stator row 16 are arranged in such a way that there are at least two of said adjacent blades, such as 18a, 18b, of downstream stator row 16, which have an azimuthal spacing Δθ or Δθᵢ between them such that:

$$\begin{matrix}{Δθ}_{i} \neq 360 ° / V ; \\ {Δθ}_{i} \geq ( 360 ° / V ) + 1 ° or {Δθ}_{i} \leq ( 360 ° / V ) - 1 ° .\end{matrix}$$

with V defining the number of blades 18 in downstream stator row 16;
and/or in such as way that there are at least two azimuthal spacings (between blades 18 of downstream stator row 16) such that the values of Δθᵢ and Δθⱼ are different when i≠j with i,j=1, 2, . . . and i,j≤V.

Note that i and j are indices. i≠j, i,j≤V, and i,j=1, 2, . . . with V therefore defining the number of blades in said downstream stator row of stator blades; i.e. i and j are different and can take an (any) integer value among 1, 2, 3, . . . and (at most) V. Only if all the azimuthal spacings are different (therefore heterogeneous) can i or j take the value i=V or j=V.

A difference of at least 1° is thus necessary to induce a significant effect linked to the heterogeneous azimuthal spacing, preferably ≥3° or even more preferably ≥5°.

Generically speaking, and as can be seen by way of non-limiting example in FIG. 3, said azimuthal spacings are each defined by the circumferential distance E between two consecutive blades, 18a, 18b, this distance varying as a function of the radial and azimuthal position of the blades 18 concerned. These azimuthal spacings may therefore be characterized by the aforementioned angle Δθ, Δθᵢ or Δθⱼ, when these axes are projected onto a plane perpendicular to longitudinal axis X of the aeronautical thruster. As a reminder, E=r*Δθ (or Eᵢ=r*Δθᵢ), with Δθ measured in radians and r being the radial distance, measured in meters, relative to longitudinal axis X.

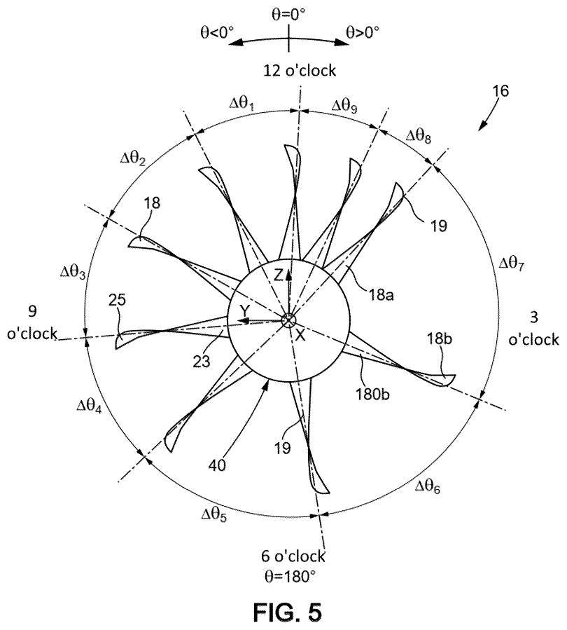

In a highly generic embodiment, all spacings between two adjacent blades of downstream stator row 16 in the azimuthal direction may be different, as illustrated in FIG. 5. This can be advantageous from an acoustic point of view, to decorrelate the sources of noise emitted by stator 16 or to modify the directivity of the sound, meaning the areas where there is maximal acoustic radiation.

Even if only one or only some of said azimuthal spacings between two adjacent blades is/are different in downstream stator row 16, under the conditions specified above, the majority of the other azimuthal spacings between two said adjacent blades then being identical, one will note that in a preferred embodiment, one or more of the parameters or features below is/are satisfied by the proposed solution:
a) at least two adjacent blades 18 have an azimuthal spacing (Δθ or Δθᵢ) such that

$$\begin{matrix}{Δθ}_{i} \neq \\ \frac{360 °}{V} ,\end{matrix}$$

where V is the number of blades in downstream stator 16. This allows ensuring that at least one blade of stator 16 is not positioned homogeneously around longitudinal axis X of the aeronautical thruster,
b) max{Δθᵢ}−min{Δθⱼ}≤120°, preferably ≤75°, or more preferably ≤50°, for i,j=1, 2, . . . with i≠j and i,j≤V (if the number of blades of stator 16 so allows, i.e. if for example V≥5); this ensures that the difference between the azimuthal spacing of any two adjacent blades 18 is limited. For example, in FIG. 4, this criterion implies that Δθ₇−Δθ₈≤120°; the concern is to avoid too large of an angular sector being completely devoid of stator blades, which could reduce the straightening of the flow downstream of rotor 14 and therefore cause a loss of thrust and efficiency. This can also pose problems concerning the weight distribution around longitudinal axis X and the thruster's integration onto the aircraft;
c) ∥Δθᵢ−Δθ_{adjacent}∥≤120°, preferably ≤75° or more preferably ≤50° (if the number of stator blades so allows, i.e. if for example V≥5); this ensures that the difference between two adjacent (consecutive) azimuthal spacings is limited. This criterion may be particularly useful for avoiding excessively large differences in spacing in an angular sector. The concern is to avoid too large of an angular sector being completely devoid of stator 16 blades, which again could reduce the straightening of the flow downstream of rotor 14 and therefore cause a loss of thrust and efficiency. Problems concerning the weight distribution around longitudinal axis X and/or integration may also arise.

The above ranges of values must also be sufficient to allow modifying the sound directivity (and thus reducing noise oriented towards the ground/fuselage) by increasing the azimuthal spacing between blades of stator 16 within a desired angular region around longitudinal axis X.

For the first point, we have already explained the impact of the forces and moments referred to as 1P forces, in the plane of rotor 14, and the unsteady aerodynamics and the forces dependent on the azimuthal position of blade 18. For example, when the aeronautical thruster is installed under the wing, a descending blade is subjected to increased forces compared to a rising blade of the rotor. Note, however, that this can be the opposite in the case where the aeronautical thruster is installed at the rear. Indeed, the airfoil can create a downward flow (“downwash”, negative angle of attack) downstream of its trailing edge. In this case, a rising blade may be subjected to increased forces compared to a descending blade. Thus, we may find ourselves in a situation of a negative or positive angle of attack upstream. Located downstream of the upstream propeller 14, the blades of stator 16 will also have a variable load depending on their azimuthal position. The following choices may then be made:
as the stator blades opposite the descending blades of rotor 14 are undergoing less load and have less twist to correct, a need for fewer blades in stator 16 in this area is taken into account: for example, a need for fewer blades in stator 16 in the right lateral area (from 45° to 135° with 0° being the position at 12 o'clock) in the case of a rotor 14 rotating clockwise as viewed from the front (upstream), and/or
as the blades of stator 16 that are axially opposite the rising blades of rotor 14 are undergoing more load and have more twist to correct, a need for more stator blades in this area is taken into account: for example, a need for more blades in stator 16 in the left lateral area (from −45° to −135° with 0° being the position at 12 o'clock) in the case of a rotor 14 rotating clockwise as viewed from the front (upstream).

Preferably, the number of different azimuthal spacings/angles Δθ, Δθᵢ, Δθⱼ varies between 2 and 6. Indeed, increasing the number of different spacings can increase the number of stator blades to be designed (several families/groups of blades would be conceivable). A design for each stator blade, adapted to its azimuthal position, may be necessary. For example, local chord modifications may be necessary to minimize azimuthal deviations in the stator blades' load, and the blade ring solidity, which is defined by the C/E ratio at a given radial position. Other geometric parameters of the blades could also vary: thickness, camber, sweep, lean, etc. This would allow the blade geometry to be better adapted to local flow properties (impacted by angle of attack) and/or to better distribute the weight of the blades of stator 16 about the longitudinal axis of the aeronautical thruster, to facilitate engine balancing.

Below, several embodiments compatible with the above characteristics and which may be preferred, are presented.

It has been identified that the noise resulting from the interaction between the wake of upstream rotor 14 and the downstream stator 16 produces “dipole” acoustic radiation on the stator blades. This implies that the interaction noise from stator 16 is not axisymmetric, but depends on the azimuthal position (or even the pitch if such exists) of the blades of stator 16. Thus, by using at least one of the above features a), b), or c), which may therefore be combined in whole or in part, it will be possible to optimize the azimuthal position of the blades of stator 16 in order to reduce the noise emitted towards the ground and/or towards the cabin (fuselage) and the passengers, and/or in any desired direction, so as to act upon at least one of the following criteria: limiting noise disturbance, facilitating thruster aerodynamics, improving the performance and integration of the aeronautical thruster installed on the aircraft.

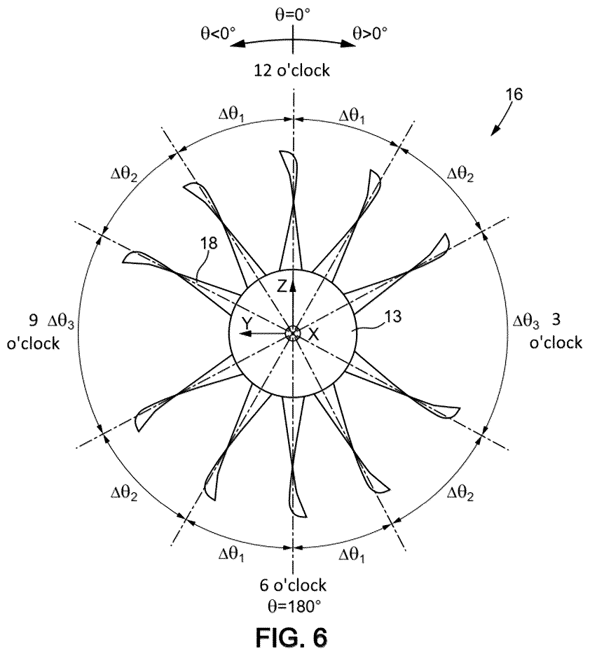

If we assume that the pitch deviations between the blades of stator 16, measured at 0.75×Re2 (reference radius) are negligible (˜0°, for example as when cruising in flight in an isolated configuration), that the blade pitch angles of stator 16 are ˜90°, and that most of the noise is generated at radially external end 25 of the blades, the blades which emit the most noise towards the ground are located at angles which vary between [2 o'clock-4 o'clock] and [8 o'clock and 10 o'clock]. Thus, one of the preferred embodiments envisages increasing the spacing between the blades (or limiting the number of blades) in these angular sectors at the sides of stator 16 (around 3 o'clock and 9 o'clock), as illustrated for example in FIG. 6.

In another configuration which is in accordance with at least one of the above features a), b), or c) and which may be preferred, the following is possible, as illustrated by way of example in FIGS. 7 to 10,
either placing a greater number of blades in stator 16:
   in the upper part (between 10 o'clock and 2 o'clock) and/or
   towards the inside, nearer fuselage 33 (between 2 o'clock and 4 o'clock if the fuselage is to the right of the thruster, when viewed from the front/upstream, or between 8 o'clock and 10 o'clock if the fuselage is to the left of the thruster, when viewed from the front/upstream);
      which will limit noise emissions towards communities. Indeed, the noise of stator 16 blades located towards the top and/or towards the inside could have reduced radiation towards the ground due to their azimuthal position and the possible screening effects produced by an attachment system 27, the airfoil 31 (if located under/on the wing), or fuselage 33,
or, if it is desired to minimize the noise radiated towards the passenger cabin (fuselage 33), placing a greater number of stator 16 blades towards the outside, diametrically opposite fuselage 33 (between 8 o'clock and 10 o'clock if the fuselage is to the right of the thruster, when viewed from the front/upstream, or between 2 o'clock and 4 o'clock if the fuselage is to the left of the thruster, as viewed from the front/upstream), so that the most numerous stator 16 blades are the furthest from the fuselage.

The final choice will depend on the noise reduction objectives for the thruster architecture, as is schematically shown in FIGS. 5 to 9.

In all these cases, increasing the number of stator 16 blades (i.e. therefore reducing the azimuthal spacing: Δθ or Δθᵢ or Δθⱼ) in the upper part of the stator can be beneficial both for acoustics and for aerodynamics, with the caveat that this may present a difficulty when integrating under the casing 13 if there is a strut, pylon, or engine mount 27 present, or any structure or system for attaching the thruster to the aircraft.

Regarding the acoustics, it is (in principle) the stator 16 blades in the upper part which radiate the least noise towards the ground. For the aerodynamics, these are among the stator 16 blades under the most load, because the upstream angle of attack (angle α/aircraft angle of attack, as in the example of FIG. 2) is not completely filtered out by upstream rotor 14.

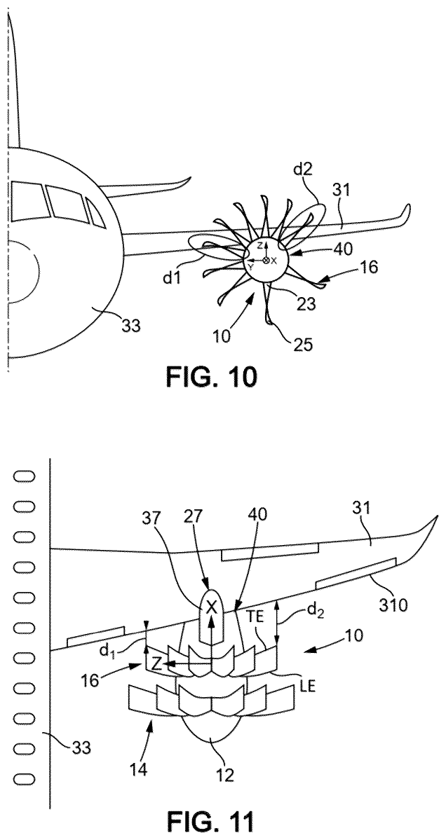

Thus, as illustrated by way of example in FIGS. 10-11, increasing the number of blades in the upper part of stator 16 would allow a better distribution of this load. Furthermore, increasing the number of stator 16 blades at the azimuthal positions close to attachment system 27, airfoil (wing) 31, or fuselage 33, may also be of interest in reducing the potential effect (pressure buildup) of this obstacle (and/or of the strut and/or of the airfoil) towards upstream rotor 14. In other words, thus increasing the number of stator 16 blades may help to “filter out” or reduce the pressure buildup related to the presence of said obstacle, at upstream rotor 14. It will then be preferable to increase the number of stator 16 blades in the angular sector of stator 16 where the distance between trailing edge TE of stator 16 blades and leading edge 310 of the airfoil (or even of attachment system 27) is smaller. In this regard, recall the useful case where d1<d2, as in the solution illustrated as an example in FIG. 11. This is particularly relevant when d1 or d2 is/are less than 0.75*D, preferably 0.5*D or more preferably 0.3*D.

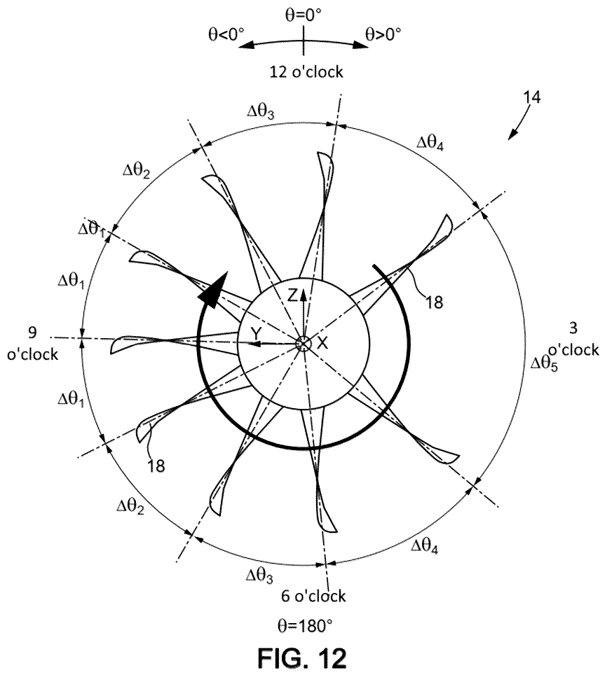

In yet another configuration in accordance with at least one of the above characteristics a), b), or c) and which may be preferred, it is possible to increase, as illustrated as an example in FIG. 12 and for mainly aerodynamic reasons, the number of blades (or therefore reduce the azimuthal spacing) at the same side as the descending blade 18 of upstream rotor 14. Indeed, the blades of stator 16 that are axially opposite the descending blades of upstream rotor 14 will be more loaded and will therefore have more twist to correct. Increasing the number of blades of stator 16 on this side would allow a better distribution of the load of these stator 16 blades, which may also be advantageous for reducing noise.

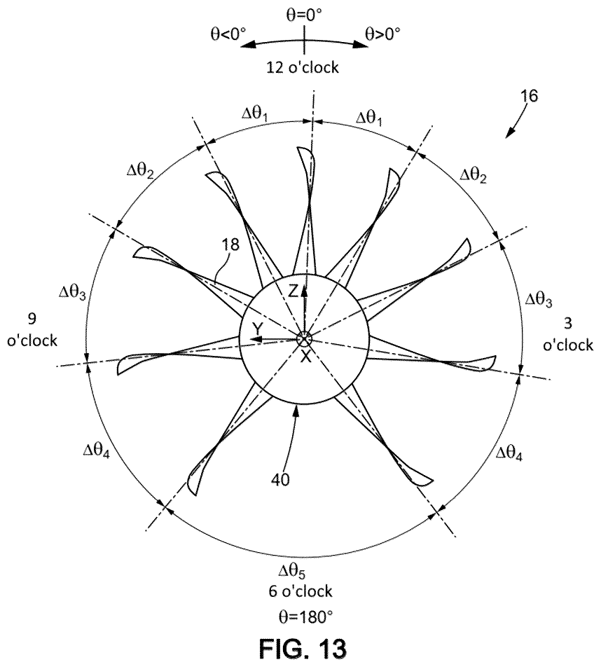

In yet another configuration in accordance with at least one of the above characteristics a), b), or c) and which may be preferred, it may be provided, as illustrated by way of example in FIG. 13, that the distributions of blades 18 of stator 16, at the right side (around 9 o'clock, as viewed from the front/upstream of the thruster) and at the left side (around 3 o'clock, as viewed from the front/upstream of the thruster) are symmetrical (for example, with respect to an axis of symmetry passing through 12 o'clock and 6 o'clock).

This allows balancing the weight of the thruster and avoiding a residual moment on longitudinal axis X, related to the heterogeneous distribution of the blades of stator 16.

In this case, the blades of stator 16 located at symmetrical positions (θ and −θ) relative to the vertical axis passing through 12 o'clock and 6 o'clock will favorably present identical geometric characteristics, in particular the thickness (e)—see example in FIG. 19, the blade height L2, L21 (or clipping), . . . , the blade pitch angle not being concerned, as this may be variable in order to adapt the angle of attack of the blades to the local flow properties, which will allow better distributing or smoothing the load on the blades in the azimuthal direction, in particular during flight phases with a greater angle of attack (angle α).

Another critical criterion that is useful to take into account for the above purposes is related to the azimuthal gap or spacing between the blades of upstream rotor 14 and those of downstream stator 16. This azimuthal spacing between the axes of the blades, or of the pitch change of the blades of rotor 14 and stator 16, is given by the relation: ∥θ_{r,n}−θ_{s,m}∥>1° or preferably ≥2°, where θ_{r,n} and θ_{s,m} correspond to the angular positions of the axis of the n^{th} blade of rotor 14 and the m^{th} blade of stator 16, respectively at an instant when the axes of the blades or of the pitch change of a blade of rotor 14 and of stator 16 are aligned when they are projected onto a plane perpendicular to longitudinal axis X. Recall that n is a natural number and varies between 1 and B (number of blades of rotor 14) and m varies between 1 and V (number of blades of stator 16).

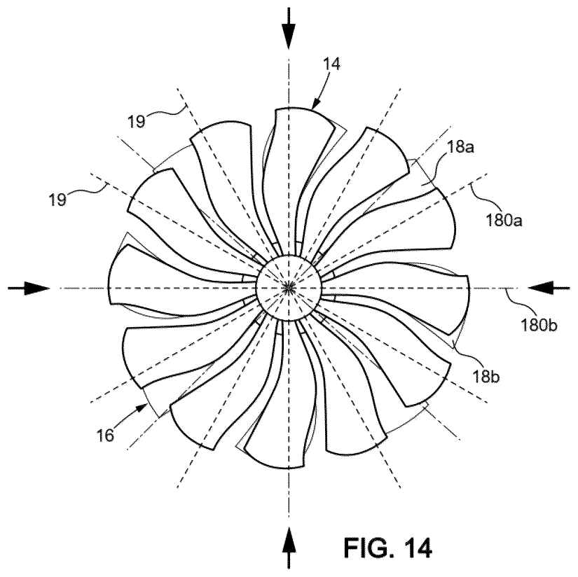

The utility of this criterion is to ensure that there is only one rotor 14 blade wake at a time that interacts with a blade of stator 16, which makes it possible to reduce the sources of noise. The implementation thus proposed allows changing the periodicity of the interaction between rotor 14 wake and stator 16 which causes the tonal interaction noise. The acoustic impact results in a reduction in the amplitude of the BPF (blade passing frequency—(noise level)) and therefore in the emergence of said BPF compared to broadband noise. The noise during flight (Effective Perceived Noise Level, EPNL, in accordance with acoustic regulations) may thus be lower, due to a reduced emergence of tonal noise compared to broadband noise. The total acoustic energy remains approximately the same, but is redistributed over higher-order harmonics. Thus, if the number of blades of rotor 14 and stator 16 does not allow this constraint to be satisfied with uniform spacing (as in the case illustrated in FIG. 14 with twelve blades in rotor 14 and eight blades in stator 16), it is possible to vary the azimuthal position/spacing of certain blades of rotor 14 and/or stator 16 in a non-uniform manner. In this case, possible variations in the blades' chord and thickness are possible in order to maintain a more or less constant average solidity C/E at each radial position. In this FIG. 14, where upstream rotor 14 and downstream stator 16 are viewed from the front, from upstream of the rotor, the blades of the downstream stator are partially hidden and:
the dashed lines indicate the stacking axes or the pitch variation axes 19 of the blades of rotor 14, and
the dotted and dashed lines indicate the stacking axes or the pitch variation axes 1) of the blades of stator 16.

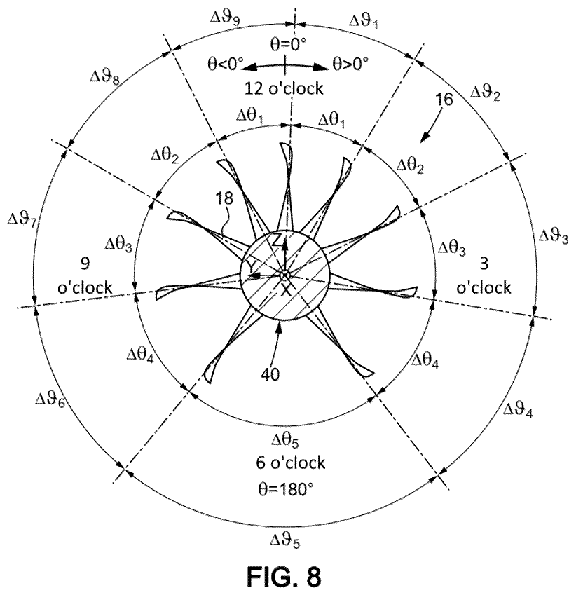

At least to minimize the azimuthal deviations in the load on the stator blades and/or to correlate noise sources between blades, a law defining the fluctuation in solidity at azimuth, for each given radius, may thus be defined, making it possible to maintain and ensure an average azimuthal solidity for each radius:

$$\overline{Π ( r )} {\sum }_{k = 1}^{V} {Π}_{k} ( r ) {Δϑ}_{k} / {\sum }_{k = 1}^{V} {Δϑ}_{k}$$

where Π̅(̅r̅)̅ denotes the average solidity at a given radius r, Πₖ(r)=Cₖ(r)/Eₖ(r) the solidity between two adjacent (consecutive) blades of stator 16, such as 18a, 18b, at a given radius r, with V being the number of blades of stator 16 and Δ∂ₖ the angular pitch between these two blades, at the same given radius r. This corresponds to the solidity C/E resulting from a mean, weighted by the azimuthal spacing; see FIG. 8 for one non-limiting example.

It may be provided that the average azimuthal solidity Π̅(̅r̅)̅ is less than 3 over the entire span and/or less than 1 at the radially external ends.

The angular pitch between two blades of downstream stator 16 or two adjacent axes is therefore considered, as defined for Δ∂ₖ. The difference between Δ∂ₖ and Δθᵢ is such that:
for Δ∂ₖ with k=1, 2, . . . , V; it may therefore have two different indices with the same azimuthal spacing (i.e. the same value in radians or degrees). Note that, for example, in FIGS. 8 and 9 there are several equal azimuthal spacings, all referred to in the same manner Δθ₁;
for Δθ₁ with i=1, 2, . . . and i≤V: each index then corresponds to an azimuthal spacing that is different or that has a different value in radians/degrees. This is the definition that is to be used by default within the framework of this disclosure.

Thus, it has unexpectedly emerged that if Π(r) satisfies the same criteria as C/E, then the performance of the results is increased by more than 3%, the results supporting this.

Yet another aspect may be considered, namely integrating at least one blade 18 of downstream stator 16 into attachment system 27 (bifurcation) in order to reduce the effects of the installation. This stator will then have a complementary structural function.

FIG. 15 represents an example of such a case. This figure shows a propulsion assembly 24 for an aircraft. Propulsion assembly 24 comprises a thruster 10 and attachment system 27, such as pylon 37, for fixing thruster 10 to the aircraft. Attachment system 27 (pylon 26) is connected to one of blades 18 of downstream stator row 16 so as to form a single aerodynamic assembly. For this purpose, attachment system 27 (pylon 37) may be connected to one of blades 18 of downstream stator 16 by being an extension of its material. In other words, attachment system 27 (pylon 26) may be integral with one of blades 18 of downstream stator 16.

Alternatively:
attachment system 27 (pylon 37) may be connected to one of blades 18 of downstream annular row 16 by one (or more) attachment means, or
the part of downstream stator 16 integrated into the attachment system may have variable pitch. Attachment system 27 (pylon 37) also has an aerodynamic profile similar to an aerodynamic profile of blades 18 of downstream stator 16. Attachment system 27 (pylon 37) therefore has the same effect on the airflow from upstream annular row 14 as blades 18 of downstream stator 16. Such an arrangement allows further reducing the noise emitted by thruster 10.

If the stator blades are identical (i.e. belong to the same family of stator blades), the channel between pylon 37 and blades 18 of downstream annular row 16 is reduced, which can generate shockwaves and accelerate the flow, subsequently causing an increase in aerodynamic losses and therefore a reduction in efficiency.

In the case of a pylon 37 connected to one of blades 18 of downstream annular row 16 by one (or more) attachment means, downstream annular row 16 may comprise blades 18 belonging to at least three families of stator blades.

As the pylon is connected to one of blades 18 of downstream annular row 16, it may be considered as being part of a family of stator blades.

It may be provided that pylon 37, and the two blades of the downstream annular row that are adjacent to pylon 37, each belong to a different family of stator blades. In other words, the two blades 18 of the downstream annular row located on either side of pylon 37, and pylon 37, belong to three different families of stator blades.

This allows for better adaptation of the aerodynamic operation of the stator blades, and, in particular, avoiding possible separations at the leading edge due to changes in the flow incidence at the leading edge of the stator blades induced by the presence of the pylon.

Yet another factor in noise reduction may be identified when, for example as in FIG. 3 or 15:
rotor 14 and stator 16 are located towards an upstream end of the thruster (“puller” configuration),
nacelle 40 has an opening 41 defining an air inlet which in particular may be an inlet for a primary air flow towards turbine engine 10 (specifically towards compressor 2), and
on nacelle 40, opening 41 is located axially between rotor 14 and stator 16, and more precisely, and preferably, between the axes of the respective blades 18 of rotor 14 and stator 16.

This makes it possible to reduce the span (and therefore Re2−Ri2 by increasing Ri2) of downstream stator 16, particularly in relation to “clipping”. The size of a blade, and in particular its span, contributes to the radiated noise. Such a configuration will thus reduce the noise of the turbine engine.

On the nacelle, air inlet 41 may be positioned along 360° (ring) or along only an angular sector. Air inlet 41 may have a protruding nozzle on the nacelle.

With such a configuration, turbine engine 10 (gas turbine/core engine) will operate conventionally, such that the air entering opening 41 will be accelerated and compressed by compressor(s) 2 before being used in the combustion chamber(s) and then passing into the turbine(s).

Independently of the nacelle, meaning when the thruster comprises a turbine engine 10 (gas turbine) comprising:
a hub 12 provided with an upstream rotor row 14, and
an engine casing 13 provided with a downstream stator row 16 located downstream (DNST) of an upstream rotor row 14,
   an air inlet—such as 41—bringing air to the compressor(s) will be beneficially located:
downstream of upstream rotor row 14 of rotor blades, and
upstream of downstream stator row 16 of stator blades,
   in other words, longitudinally along the thruster, between the rotor blades and the stator blades.

As is understood, such a turbine engine may then comprise, successively along the longitudinal axis (X) from upstream to downstream:
at least one compressor 2,
at least one combustion chamber 6,
at least one turbine 4 driving the compressor(s), and
said air inlet 41.

This has the consequence that the radial dimension of blades 18 of downstream annular row 16 could be even further reduced in order to escape the vortices formed at the tips of blades 18 of upstream annular row 14, which reduces the efficiency of turbine engine 10.

1-32. (canceled)

33. An aeronautical thruster (10) having a longitudinal axis (X) and comprising a casing (13) and, spaced apart from each other along said longitudinal axis (X), an upstream rotor row (14) of rotor blades which are unducted and a downstream stator row (16) of stator blades which are unducted and extend around the casing (13), two adjacent blades (18a, 18b) of said downstream stator row (16) of stator blades having an azimuthal spacing (Δθ, Δθᵢ, Δθⱼ) between them, about the longitudinal axis (X), that is defined by the angle between respective axes (180a, 180b, 19), the axes being either:
pitch angle adaptation axes of said two adjacent blades, when these axes are projected onto a plane perpendicular to the longitudinal axis (X) and if said two adjacent blades have a variable pitch angle, or
axes radial to the longitudinal axis (X) and passing through radially internal ends (23) or radially external ends (25) of said two adjacent blades or through their centers of gravity, respectively, if said two adjacent blades have a fixed pitch angle, or
for one of said respective axes, a pitch angle adaptation axis of one of said two adjacent blades, when the blade has a variable pitch angle, and, the other axis being radial to the longitudinal axis (X) and/or passing through the radially internal end (23) or the radially external end (25) or through the center of gravity of said adjacent blade, when the latter has a fixed pitch angle, and
about the longitudinal axis (X), an angular position at 12 o'clock is defined as being positioned vertically upwards relative to the longitudinal axis (X) and an angular position at 6 o'clock as positioned vertically downwards relative to the longitudinal axis (X),
this assembly being characterized in that at least some of said blades of said downstream stator row (16) of stator blades have a heterogeneous distribution about the longitudinal axis (X), such that:
there are at least two of said adjacent blades of said downstream stator row (16) of stator blades which have an azimuthal spacing Δθᵢ between them such that Δθᵢ≠360°/V; Δθᵢ≥(360°/V)+1° or Δθᵢ≤(360°/V)−1°, and/or
there are at least two azimuthal spacings such that the values of Δθᵢ and Δθⱼ are different when i≠j with i,j=1, 2, . . . and i,j≤V,
with V defining the number of blades in said downstream stator row (16) of stator blades,
wherein there are at least three families of stator blades, preferably at least five families of stator blades, and wherein each family of stator blades comprises one or more stator blades, the stator blades of a same family which comprises several stator blades having the same set of geometric characteristics, wherein at least one geometric characteristic in the set of geometric characteristics is different from the same geometric characteristics of the stator blades of another family of stator blades.

34. The aeronautical thruster (10) according to claim 33, wherein Δθᵢ≥(360°/V)+3° or Δθᵢ≤(360°/V)−3°, or preferably Δθᵢ≥(360°/V)+5° or Δθᵢ≤(360°/V)−5°.

35. The aeronautical thruster (10) according to claim 33, wherein, for at least one among the upstream rotor row (14) of rotor blades and the downstream stator row (16) of stator blades, there is a C/E ratio of a chord, C, and the azimuthal spacing, E between two consecutive blades of the downstream stator (16), about the longitudinal axis (X), such that C/E is less than 3 over the entire span.

36. The aeronautical thruster (10) according to claim 35, wherein the C/E ratio is less than 1 at the radially external ends (25) of two blades of the same upstream rotor row and/or downstream stator row, said blades being circumferentially or azimuthally consecutive, or adjacent.

37. The aeronautical thruster (10) according to claim 33, wherein, for at least one among the upstream rotor row (14) of rotor blades and the downstream stator row (16) of stator blades, an average azimuthal solidity Π̅(̅r̅)̅ is less than 3 over the entire span and/or less than 1 at the radially external ends, where Π̅(̅r̅)̅ denotes the average solidity at a given radius r, Πₖ(r)=Cₖ(r)/Eₖ(r) denotes the solidity between two adjacent stator blades at a given radius r, V is the number of stator blades, and Δ∂ₖ is the angular pitch between these two blades, at the same given radius r.

38. The aeronautical thruster (10) according to claim 33, wherein a number B of blades of the upstream rotor row (14) of rotor blades is greater than the number V of blades (18) of the downstream stator row (16) of stator blades, and preferably B≥V+1, or more preferably B≥V+2.

39. The aeronautical thruster (10) according to claim 33, wherein the radially external ends of the blades (18) of the downstream stator row (16) of stator blades are inscribed within an encircling envelope (22) for which the projection onto a plane (IV-IV) perpendicular to the longitudinal axis (X) defines a circle.

40. The aeronautical thruster (10) according to claim 33, wherein the radially external end of each blade (18) of the upstream rotor row (14) of rotor blades is inscribed within a first circle (20) and the radially external end of each blade (18) of the downstream stator row (16) of stator blades is inscribed within a second circle (22), the radius (Re2) of the second circle (22) being less than the radius (Re1) of the first circle (20).

41. The aeronautical thruster (10) according to claim 40, wherein the center of said circle within which the radially external end of each blade (18) of the downstream stator row (16) of stator blades is inscribed is offset relative to the longitudinal axis (X).

42. The aeronautical thruster (10) according to claim 33, wherein max{Δθᵢ}−min{Δθⱼ}≤120°, preferably ≤75°, or more preferably ≤50°, for i,j=1, 2, . . . with i≠j and i,j≤V.

43. The aeronautical thruster (10) according to claim 33, wherein ∥Δθᵢ−Δθ_{adjacent}∥≤120°, preferably ≤75°, or more preferably ≤50°, for i=1, 2, . . . with i≤V.

44. The aeronautical thruster (10) according to claim 33, wherein the number of different azimuthal spacings (Δθ, Δθᵢ, Δθⱼ) across all the blades (18) of said downstream stator row (16) of stator blades is between 2 and 6.

45. The aeronautical thruster (10) according to claim 33, wherein a ratio of:
a distance(S), along the longitudinal axis (X), between the two center planes perpendicular to the longitudinal axis, respectively of the upstream rotor row (14) of rotor blades and of the downstream stator row (16) of stator blades, and
a maximum diameter (D) of the aeronautical thruster (10), at the radially external ends of the blades (18) of the upstream rotor row (14) of rotor blades or of the downstream stator row (16) of stator blades, is between 0.01 and 0.8, or preferably between 0.15 and 0.35.

46. The aeronautical thruster (10) according to claim 33, wherein the numbers of blades (18) of the upstream rotor row (14) and of the downstream stator row (16) are, respectively, 12 and 10, or 14 and 12, or 14 and 11.

47. The aeronautical thruster (10) according to claim 33, wherein the set of geometric characteristics of a stator blade comprises the chord, the thickness, and the height.

48. The aeronautical thruster (10) according to claim 47, wherein the set of geometric characteristics of a stator blade further comprises at least one among the camber, the sweep, and the lean.

49. The aeronautical thruster (10) according to claim 33, wherein the row of stator blades comprises at least three adjacent stator blades which each belong to different families of stator blades.

50. The aeronautical thruster (10) according to claim 33, wherein an attachment system (27) is connected to one of the blades (18) of the downstream annular row by one or more attachment means.

51. The aeronautical thruster (10) according to claim 50, wherein the attachment system (27) is a pylon (37).

52. The aeronautical thruster (10) according to claim 51, wherein the pylon (37), and the two blades (18) of the downstream stator row that are adjacent to the pylon (37) each belong to a different family of stator blades.
